(19) United States
(12) Patent Application Publication
(10) Pub. No.: US 2020/0047488 A1
(43) Pub. Date: Feb. 13, 2020

(54) PROTECTIVE SHEET, ENDLESS BELT LAMINATE, ENDLESS BELT ASSEMBLY, PACKAGE AND MOUNTING JIG

(71) Applicant: CANON KABUSHIKI KAISHA, Tokyo (JP)

(72) Inventors: Toru Yamane, Yokohama-shi (JP); Mineto Yagyu, Hachioji-shi (JP); Kenji Hasegawa, Kawasaki-shi (JP); Masahiro Sugimoto, Yokohama-shi (JP); Nobuo Komiya, Yokohama-shi (JP); Hitomi Ogasawara, Kawasaki-shi (JP); Hideki Takaoka, Kawasaki-shi (JP); Takeho Miyashita, Yokohama-shi (JP)

(21) Appl. No.: 16/532,262

(22) Filed: Aug. 5, 2019

(30) Foreign Application Priority Data
Aug. 7, 2018 (JP) 2018-148532
Aug. 7, 2018 (JP) 2018-148533

(51) Int. Cl. B41J 2/005

(52) U.S. Cl. CPC B41J 2/0057

(57) ABSTRACT

A protective sheet is to be laid on an endless belt sheet and covers a surface of the endless belt sheet to protect the surface. When the protective sheet is laid on the endless belt sheet, the bending stiffness of the protective sheet is lower in the circumferential direction of the endless belt sheet than in the width direction that is orthogonal relative to the circumferential direction. Thus, the risk of being bent and damaged of the endless belt sheet is minimized and the cumbersomeness of the operation of replacing the endless belt sheet is remarkably reduced by using such a protective sheet.

### BACKGROUND

### Field

The present disclosure relates to a protective sheet, an endless belt laminate, an endless belt assembly (also referred to simply as “a cartridge” in the below), a package and a mounting jig.

### Description of the Related Art

Phenomena such as curling and cockling can take place on recording mediums for inkjet printing when the recording mediums excessively absorb liquid from the liquid ink being used in image forming operations of ejecting liquid ink containing a coloring material and a liquid component from inkjet printers onto recording mediums, which may typically be sheets of paper. With a technique for avoiding such phenomena, the inkjet printer is made to include a transfer body and an intermediate image is formed on the transfer body such that the liquid component contained in the intermediate image on the transfer body is eliminated before the image is transferred onto a recording medium. Japanese Patent Application Laid-Open No. 2009-45851 proposes a method of absorbing the liquid component from the image on the transfer body by bringing a roller-shaped porous body into contact with the image and eliminating the liquid component contained in the image on the transfer body. Japanese Patent Application Laid-Open No. 2009-61644 discloses a liquid recovery method of using a negative pressure for the purpose of recovering the liquid absorbed by the porous body. With the disclosed liquid recovery method of using a negative pressure, liquid can efficiently be recovered by causing the porous body to be saturated with liquid prior to the liquid recovering operation, thereby eliminating any air leakage because air leakage can adversely affect the liquid recovering performance of the porous body. Japanese Patent Application Laid-Open No. 2009-916 discloses an endless belt on which an image to be transferred to a recording medium is formed by an inkjet technique. Additionally, Japanese Patent Application Laid-Open No. 2017-136838 proposes a method of using an endless belt, which is a sheet-like porous body, by causing the endless belt to contact the image, thereby absorbing and eliminating the liquid contained in the image. Finally, Japanese Patent Application Laid-Open No. 2001-282075 proposes a cartridge-like replacement unit to be used for replacing the intermediate transfer belt, which is an endless belt, or the photosensitive belt, which is also an endless belt.

The inventors of the present disclosure closely looked into the techniques disclosed in the above-identified patent documents and found that the liquid recovery method of using a negative pressure as described in Japanese Patent Application Laid-Open No. 2009-61644 requires a huge energy load. On the other hand, the method of using a sheet-like porous body for the purpose of eliminating liquid from the rear surface thereof as disclosed in Japanese Patent Application Laid-Open No. 2017-136838 is advantageous from the viewpoint of energy load. However, the use of a sheet-like porous body in turn requires the use of various units including a unit of means for applying tensile force to the endless belt, which is a sheet-like porous body, a unit of means for recovering liquid from the endless belt and a unit of means for cleaning the endless belt. Then, the route of circulating movement of the endless belt itself is inevitably made to be a complex one because these various units need to be arranged along the endless belt and engaged with the latter. Furthermore, in the instance of using an intermediate transfer belt, which is an endless belt, or a photosensitive belt, which is also an endless belt, as described in Japanese Patent Application Laid-Open No. 2001-282075, the route of circulating movement can also become a complex one.

In the instance of large printers that can accommodate A2 paper size and B2 paper size, the endless belt, which is a sheet-like porous body, is made to show very large dimensions. When such a large endless belt having a complex route of circulating movement is involved, the operation of replacing the endless belt inevitably becomes a cumbersome one. Additionally, when the endless belt, which is a sheet-like porous body and designed to be brought into direct contact with the image on the intermediate transfer body, has a damaged or bent part, if slightly, the image can become a defective one as a result of direct contact of the image with the damaged or bent part. After all, it is very difficult to mount a very large endless belt, which is a sheet-like porous body and has a complex route of circulating movement, into the printer main body without producing any damaged or bent part on it. Thus, in view of the cumbersome operation of replacing the endless belt and the risk of producing a defective image, providing liquid ejection apparatus, of which the endless belt can arbitrarily be replaced by the user or the operator, is accompanied by a considerable risk particularly when the liquid ejection apparatus is a very large one. Differently stated, the complex route of circulating movement of the endless belt and the potential adverse effect of a damaged or bent part of the endless belt on the produced image constitute a very high barrier to commercializing liquid ejection apparatus of which the endless belt can arbitrarily be replaced by the user or the operator.

### SUMMARY

In view of the above-identified circumstances, the present disclosure provides a protective sheet, an endless belt laminate (comprising an endless belt and a protective sheet), an endless belt assembly (or a ‘cartridge’ as mentioned above comprising an endless belt laminate rigidly secured by a binding member), a package (i.e. a packing box containing an endless belt assembly) and a mounting jig (for mounting an endless belt sheet into a recording apparatus) that can practically prevent any damaged or bent part from appearing on the endless belt sheet of a liquid ejection apparatus and remarkably reduce the cumbersomeness of the operation of replacing the endless belt sheet.

A protective sheet according to the present disclosure is a protective sheet for covering a surface of an endless belt sheet to protect the surface. The protective sheet is characterized in that a bending stiffness thereof is lower in a circumferential direction of the endless belt sheet than in a width direction that is orthogonal relative to the circumferential direction.

Further features of the present disclosure will become apparent from the following description of exemplary embodiments with reference to the attached drawings.

### BRIEF DESCRIPTION OF THE DRAWINGS

FIG. 1 is a schematic illustration of an exemplar liquid ejection apparatus to which the present disclosure is applicable.

FIG. 2 is a schematic perspective view of the recording unit of the liquid ejection apparatus shown in FIG. 1.

FIG. 3 is a schematic illustration of the sequence of an exemplar operation of the liquid ejection apparatus of FIG. 1.

FIGS. 4A, 4B, 4C and 4D are a schematic illustration of an exemplar operation of the liquid recovery unit of the liquid ejection apparatus of FIG. 1.

FIG. 5 is a schematic perspective view of the endless belt sheet of the liquid recovery unit shown in FIGS. 4A through 4D.

FIG. 6 is an enlarged schematic cross-sectional view of Part A shown in FIG. 5.

FIG. 7 is a schematic perspective view of the cartridge that includes the endless belt sheet shown in FIG. 5.

FIG. 8 is an enlarged schematic cross-sectional view of Part B shown in FIG. 7.

FIG. 9 is a schematic perspective view of the shell that operates as part of the cartridge shown in FIG. 7.

FIGS. 10A and 10B are a schematic perspective view and an enlarged schematic perspective view of a part of the shell shown in FIG. 9.

FIGS. 11A, 11B, 11C and 11D are enlarged schematic cross-sectional views of so many exemplar shells similar to the one shown in FIG. 9.

FIG. 12 is a schematic illustration of another exemplar liquid ejection apparatus to which the present disclosure is applicable.

FIGS. 13A and 13B are schematic perspective views of the cartridge shown in FIG. 7, illustrating the former half of the steps of the method of packaging the cartridge.

FIGS. 14A, 14B, 14C, 14D, 14E, 14G, 14H and 14I are a schematic illustration of the steps of the sequential operation of the method of packing the cartridge shown in FIG. 7.

FIG. 15 is a flow chart of the method of packing the cartridge shown in FIGS. 13A, 13B and 14A through 14I.

FIGS. 16A, 16B, 16C, 16D, 16E, 16F, 16G and 16H are a schematic illustration of the steps of the sequential operation of the method of mounting the cartridge shown in FIG. 7.

FIGS. 17A, 17B, 17C, 17D and 17E are schematic front views of the cartridge shown in FIG. 7, sequentially illustrating the steps of moving the protective sheet away from the cartridge that has been mounted by the method illustrated in FIGS. 16A through 16H.

FIG. 18 is a flow chart of the method of mounting the endless belt sheet illustrated in FIGS. 16A through 16H and 17A through 17E.

FIGS. 19A, 19B and 19C are schematic perspective views of the mounting jig for mounting the cartridge shown in FIG. 7.

FIG. 20A is a schematic perspective view of the cartridge that includes the endless belt sheet of the liquid ejection apparatus shown in FIG. 12 and FIG. 20B is an enlarged schematic cross-sectional view of Part B shown in FIG. 20A.

FIG. 21 is a schematic perspective view of the laminate of Example 4 of the present disclosure.

FIGS. 22A, 22B, 22C and 22D are a schematic illustration of the steps of the method of packing the laminate shown in FIG. 21.

FIGS. 23A and 23B are schematic views of an exemplar packing box of a known endless belt.

FIGS. 24A, 24B, 24C and 24D are schematic illustrations of the relationships of the coefficients of friction between the endless belt and the first protective sheet and those between the first protective sheet and the second protective sheet.

FIGS. 25A, 25B, 25C and 25D are a schematic illustration of the steps of the method of preparing a laminate used in Specific Example.

### DESCRIPTION OF THE EMBODIMENTS

Now, exemplary embodiments of the present disclosure will be described by referring to the drawings. In each of the drawings, arrows X and Y indicate two directions that orthogonally intersect each other on a horizontal plane and arrow Z indicates the direction that is perpendicular to the horizontal plane.

<Recording Apparatus>

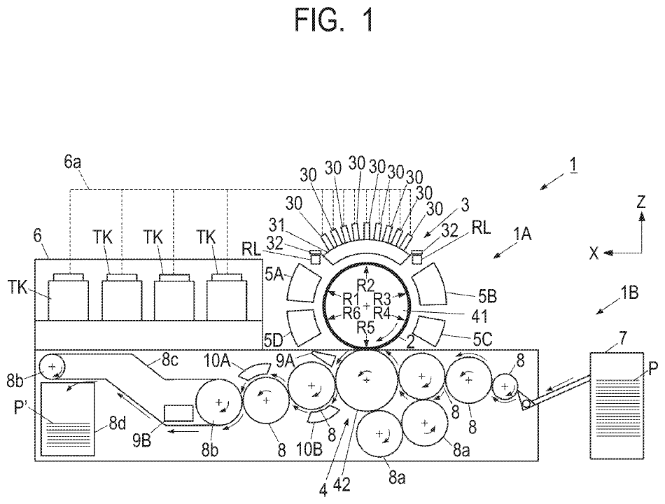

FIG. 1 is a schematic front view of a recording apparatus (image forming apparatus) 1 to which an embodiment of the present disclosure is applicable. The recording apparatus 1 is a single leaf type inkjet printer (liquid ejection apparatus) designed to produce a record P′ at a time firstly by forming an image on a transfer body 2 by ejecting liquid ink onto the transfer body 2 and subsequently transferring the image on the transfer body 2 onto a recording medium P. The recording apparatus 1 includes a recording mechanism 1A and a conveyance mechanism 1B. For this recording apparatus, the X-direction, the Y-direction and the Z-direction respectively indicate the width direction (longitudinal direction), the depth direction and the height direction of the recording apparatus 1. The recording medium P is conveyed in the X-direction.

As far as this patent application is concerned, the expression of “recording” encompasses not only instances where meaningful information is made visible by using one or more characters, one or more images and/or one or more other means of expression but also instances where one or more images and/or one or more patterns are formed regardless if such images and/or patterns are meaningful or meaningless and instances where one or more recording mediums are processed in some way or another. In other words, the expression of “recording” does not matter if something that can be visually recognizable to humans is produced or not. For this recording apparatus, a “recording medium” may not necessarily be a sheet of paper and may alternatively be a sheet of cloth or a sheet of plastic film. While the ingredients of the liquid ink ejected by the recording mechanism 1A are not subject to any particular limitations, aqueous ink containing a pigment, which is a coloring material, and a liquid component (e.g., water) is employed for this recording apparatus.

<Recording Mechanism>

The recording mechanism 1A includes a recording unit 3, a transfer unit 4, peripheral units 5A through 5D and a supply unit 6.

<Recording Unit>

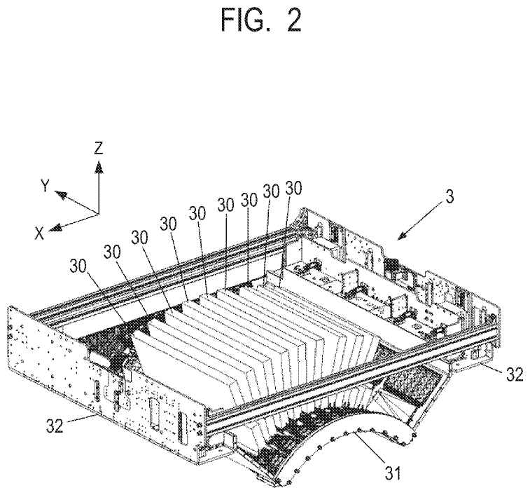

The recording unit 3 in turn includes a plurality of recording heads 30 and a carriage 31. FIG. 1 and FIG. 2, which is a perspective view of the recording unit 3, will be referred to in the following description of the recording unit 3. The recording heads 30 eject liquid ink onto the transfer body 2 to form an image to be recorded (ink image) on the transfer body 2 by means the liquid ink. The recording heads 30 of this recording apparatus are full line heads and each of them is so arranged as to extend in the Y-direction and the ejection orifices of the recording heads 30 are so arranged as to cover the entire width of the image recording region of any recording medium having the largest size that the recording apparatus 1 can accept for use. Each of the recording heads 30 has a first surface (ink ejection surface) where the ejection orifices of the recording head are open and exposed, which first surface is to be placed vis-à-vis the surface of the transfer body 2 with a slight gap (e.g., several millimeters) interposed between them. The transfer body 2 of this recording apparatus 1 is arranged at the outer peripheral surface of a revolvable tubular transfer cylinder 41 and makes a circulating movement along a circular orbit (that agrees with the outer peripheral surface of the transfer cylinder 41) in synchronism with the revolution of the transfer cylinder 41. The plurality of recording heads 30 are radially arranged along the circulatory orbit of the transfer body 2 and hence along the outer peripheral surface of the transfer cylinder 41.

The recording heads 30 are provided with energy generating elements that respectively corresponds to the ejection orifices of the recording heads 30. The energy generating elements are elements for generating energy to be used to eject liquid in the liquid flow paths of the recording heads 30 from the ejection orifices. They may be similar to those that are being employed in any of the known liquid ejection heads. Examples of known energy generating elements include electro-thermal conversion elements, electro-mechanical conversion elements and static electricity generating elements. Out of the above-listed various energy generating elements, the use of electro-thermal conversion elements is preferable from the viewpoint of high density and high speed recording.

This recording apparatus 1 comprises nine (9) recording heads 30 for ejecting inks of mutually different types. Inks of different types refer to inks using different coloring materials such as yellow ink, magenta ink, cyan ink and black ink. The plurality of recording heads 30 may include recording heads for ejecting ink that does not contain any coloring material (clear ink) as part of them. While each of the recording heads 30 of this recording apparatus 1 ejects ink of a single type, each of the recording heads 30 may be so arranged as to eject inks of a plurality of different types.

The carriage 31 supports the plurality of recording heads 30. Each of the recording heads 30 is rigidly held to the carriage 31 at opposite ends of the ejection orifice side surface of the recording head 30 such that the gap between the ejection orifice side surface and the transfer body 2 is accurately, reliably and constantly held to show an intended value. The carriage 31 has sliding sections 32 respectively arranged at the lateral sides of the carriage 31 and running in the X-direction and the sliding sections 32 are respectively held in slidable engagement with rail-like guide members RL that extend in the Y-direction (see FIG. 1). As a result of this arrangement, the carriage 31 that carries the plurality of recording heads 30 can be guided by the guide members RL and displaced.

<Transfer Unit>

Now, the transfer unit 4 will be described below by referring to FIG. 1. The transfer unit 4 includes the transfer cylinder 41 and an impression cylinder 42. These cylinders are revolving cylindrical bodies that revolve around respective axes of revolution that extend in the Y-direction. As indicted by arrows in FIG. 1, the transfer cylinder 41 revolves clockwise, whereas the impression cylinder 42 revolves counterclockwise.

The transfer cylinder 41 is a support body that supports the transfer body 2 on the outer peripheral surface thereof. The transfer body 2 is arranged on the outer peripheral surface of the transfer cylinder 41 and may be a continuous body arranged continuously in the circumferential direction on the outer peripheral surface of the transfer cylinder 41 or realized in the form of a number of constituent members that are intermittently arranged in the circumferential direction on the peripheral surface of the transfer cylinder 41. When the transfer body 2 is made to extend continuously, the transfer body 2 is formed as an endless belt. When, on the other hand, the transfer body 2 is arranged intermittently, the transfer body 2 is realized in the form of a plurality of belt-like segments having ends and the segments are arranged on the outer peripheral surface of the transfer cylinder 41 at regular intervals so as to show arc-like profiles as viewed from a lateral side of the transfer cylinder 41.

As the transfer cylinder 41 revolves, the transfer body 2 makes a circulating movement along its circular orbit. Depending on the rotational phase of the transfer cylinder 41, the transfer body 2 can be in one of the regions of pre-ejection processing region R1, ejection region R2, post-ejection processing regions R3 and R4, transfer region R5 and post-transfer processing region R6. In other words, the transfer body 2 sequentially passes through the above-listed regions R1 through R6.

The pre-ejection processing region R1 is a region where a pre-processing operation (e.g., application of reaction liquid) is executed to the transfer body 2 by peripheral unit 5A prior to an operation of ink ejection by the recording unit 3. The ejection region R2 is a region where the recording unit 3 ejects ink onto the transfer body 2 and forms an ink image on the transfer body 2. The post-ejection processing regions R3 and R4 are regions where post-processing operations are executed to the ink image respectively by peripheral units 5B and 5C after the operation of ink ejection. The transfer region R5 is a region where the ink image on the transfer body 2 is transferred onto a recording medium P by the transfer unit 4. The post-transfer processing region R6 is a region where a post processing operation is executed to the transfer body 2 by the peripheral unit 5D after the transfer operation. In the instance of this recording apparatus, the ejection region R2 is broader than the other regions R1 and R3 through R6.

The transfer body 2 may be a single layered structure or a laminate having a plurality of layers. When the transfer body 2 is formed as a laminate, it may include a surface layer, an elastic layer and a compressible layer. If such is the instance, the surface layer is the outermost layer having an image forming surface where ink images are to be formed and the compressible layer is a layer for absorbing deformations and for dispersing local pressure fluctuations for the purpose of maintaining the image transferability of the transfer body 2 even in high-speed recording operations, the elastic layer being an intermediary layer located between the surface layer and the compressible layer.

While any of various materials including resin materials and ceramic materials may appropriately be employed for the surface layer, the use of a material showing a high modulus of compressive elasticity is preferable from the viewpoint of durability. Examples of materials that show a high modulus of compressive elasticity include acrylic resin materials, acrylic silicon resin materials, fluorine-containing resin materials and condensate materials that can be obtained by condensing a hydrolysable organic silicon compound. The surface layer may be subjected to a surface treatment for the purpose of improving the wettability thereof relative to the reaction liquid to be used and the image transferability thereof. The surface treatment techniques that can be used for the surface layer include frame treatment, corona treatment, plasma treatment, polishing treatment, roughening treatment, active energy ray irradiation treatment, ozone treatment, surfactant treatment and silane coupling treatment. Two or more than two of these treatment techniques may be combined for the surface treatment of the surface layer. Additionally, the surface layer may be made to show any arbitrarily selected profile.

Examples of materials that can be used for the compressible layer include acrylonitrile-butadiene rubber, acrylic rubber, chloroprene rubber, urethane rubber and silicon rubber. The selected rubber material may be a porous rubber material with which a vulcanizing agent, a vulcanization accelerator, a foaming agent and/or a filler material such as hollow micro-particles or salt is mixed at the time of molding. As pressure is applied to a porous rubber material, it is compressed because the air bubbles it contains are forced to change their volumes under various pressure fluctuations and, therefore, it will be deformed only slightly in directions other than the direction in which the pressure is applied. The net result will be that such a porous rubber material can provide a stable transferability and a desirable durability. A porous rubber material to be used for the purpose of the present disclosure may have a continuous pore structure where pores are continuously connected, an independent pore structure where pores are independent from each other or a structure obtained by combining the above-described two structures.

Examples of materials that can be used for the elastic layer include resin materials and ceramic materials. While any of those materials may appropriately be employed for the purpose of the present disclosure, the use of a material selected from various elastomer materials and rubber materials is preferable from the viewpoint of processing characteristics. Particularly, the use of silicon rubber, fluorosilicone rubber, or phenyl silicone rubber is advantageous in terms of dimensional stability and durability because the above-listed rubbers show only small permanent compression set. Furthermore, the use of any of the above-listed rubbers is advantageous in terms of transferability because the modulus of elasticity of any of them changes only to a small extent if the ambient temperature changes remarkably.

The impression cylinder 42 is held in pressure contact with the transfer body 2 at its outer peripheral surface. The impression cylinder 42 is provided on its outer peripheral surface with at least a grip mechanism for holding a recording medium P at the front end of the latter. A plurality of grip mechanisms may be arranged in the circumferential direction of the impression cylinder 42 such that they are appropriately separated from each other. The recording medium P gripped by the impression cylinder 42 is held in tight contact with the outer peripheral surface of the impression cylinder 42 as it is conveyed by the latter and the ink image on the transfer body 2 is transferred onto the recording medium P when the recording medium P passes through the nip section of the impression cylinder 42 and the transfer body 2.

<Peripheral Units>

The peripheral units including application unit 5A, absorption unit 5B, heating unit 5C and cleaning unit 5D are arranged around the transfer cylinder 2 of this recording apparatus. The application unit 5A is a mechanism (which may typically be a roller, a recording head, a dye coater or a plate coater) for applying reaction liquid onto the transfer body 2 prior to an ink ejecting operation of the recording unit 3. Reaction liquid to be used for this recording apparatus is a liquid that contains an ingredient for raising the viscosity of ink. A material that agglomerates the coloring material contained in ink typically by changing the pH value of the ink such as metal ions, a polymer coagulant or an organic acid can be used for reaction liquid. As reaction liquid is applied onto the transfer body 2 prior to an operation of ejecting ink onto the transfer body 2, the ink that gets to the transfer body 2 can immediately be fixed to minimize the phenomenon of bleeding, where the inks that are applied at positions located close to each other are mixed with each other.

The absorption unit 5B is a mechanism for absorbing the liquid component from the ink image on the transfer body 2. As the liquid content of the ink image is reduced, the phenomenon of bleeding of the image recorded on the recording medium P can be minimized. A reduction of the liquid content of the ink image means condensation of the ink of the ink image on the transfer body 2 and hence an increase of the content ratio of the solid such as the coloring material and the resin contained in the applied ink relative to the content ratio of the liquid component in the applied ink. The absorption unit 5B typically includes a liquid absorbing member that reduces the liquid content of the ink image by contacting the ink image. The liquid absorbing member may be a sheet in the form of endless belt that is prepared by using a sheet-like porous body to be brought into contact with ink images. From the viewpoint of protecting the ink image, the absorption unit 5B, the absorbing member in particular, may be made to move (make a circulating movement) at a speed equal to the circumferential speed of the transfer body 2 so as to move in synchronism with the transfer body 2. To minimize the adhesion of the solid component of ink to the liquid absorbing member, the pore size of the porous body at the surface thereof that is to be brought into contact with ink images may be not more than 10 μm. The expression of “pore size” as used herein refers to the average pore diameter, which can be observed by means of a known technique such as a mercury press-in method, a nitrogen adsorption method or an SEM image observation method. The liquid component to be absorbed by the liquid absorbing member is not subject to any particular limitations so long as it is amorphous and fluid and shows a substantially constant volume. The liquid component may typically be water or an organic solvent that is normally contained in ink and reaction liquid. The absorption unit 5B will be described in greater detail hereinafter.

The heating unit 5C is a mechanism for heating the ink image on the transfer body 2 prior to the operation of transferring the ink image and can be formed by using a known heating device such as any of various lamps including an infrared lamp or any of various hot air fans. Particularly, the use of an infrared heater may be preferable from the viewpoint of heating efficiency. As the ink image is heated, the resin in the ink image becomes molten to improve the transferability of the ink image onto a recording medium P. The heating temperature is not lower than the minimum filming temperature (MFT). The ink image may be heated to a temperature higher than MFT by not less than 10° C. and, moreover, to a temperature higher than MFT by not less than 20° C. from the viewpoint of transferability and robustness of the ink image.

The cleaning unit 5D is a mechanism for cleaning the outer peripheral surface of the transfer body 2 after the transfer operation and eliminating the ink and the dust remaining on the transfer body 2. The cleaning unit 5D may take any known shape such as a roller shape or a web shape and use any known cleaning method such as a method of causing a porous member to contact the transfer body 2, a method of rubbing the surface of the transfer body 2 by means of a brush or a method of scraping the surface of the transfer body 2 by means of a blade.

One or more of the above-described peripheral units (application unit 5A, absorption unit 5B, heating unit 5C and cleaning unit 5D) may be provided with a functional feature of cooling the transfer body 2 or the peripheral units may be made to additionally include a cooling unit (not shown). When the temperature of the transfer body 2 is raised above the boiling point of water, which is the main ink solvent, by the heat applied by the heating unit 5C after the ejection of ink onto the transfer body 2 by the recording unit 3, the performance of the absorption unit 5B of absorbing the liquid component of the ink image on the transfer body 2 can fall. In other words, the performance of the absorption unit 5B of absorbing the liquid component can be maintained by cooling the transfer body 2 so as to keep the temperature of the ink on the transfer body 2 below the boiling point of water. The cooling unit may be an air blowing mechanism for sending air to the transfer body 2 or may include a member to be brought into contact with the transfer body (e.g., a roller) and a mechanism for cooling the member by means of air or water. Alternatively, the cooling unit may be a mechanism for cooling the cleaning member of the cleaning unit 5D. The cooling operation of the cooling unit may be executed during the time interval that comes after the transfer of the ink image on the transfer body 2 and before the application of reaction liquid.

<Supply Unit>

The supply unit 6 is a mechanism for supplying ink to each of the recording heads 30 of the recording unit 3. The supply unit 6 has storage sections TK for storing inks of different colors and flow paths 6a such that inks are supplied from the respective storage sections TK to the recording heads 30 by way of the respective flow paths 6a. The storage sections TK may include main tanks and sub tanks. The flow paths 6a may be adapted to circulate inks respectively between the storage sections TK and the recording heads 30. The supply unit may be provided with pumps, degassing mechanisms and valves.

<Conveyance Unit>

The conveyance unit 1B is a unit for supplying the transfer unit 4 with a recording medium P at a time and discharging the record P′, onto which an ink image has been transferred, from the transfer unit 4. The conveyance unit 1B includes a feeding unit 7, a plurality of conveyance cylinders 8, 8a, . . . , a pair of sprockets 8b, a chain 8c and a collection unit 8d. In FIG. 1, the revolving directions of the revolving members of the conveyance unit 1B and the conveyance route of the recording medium P or the record P′ are indicated by respective arrows. The feeding unit 7 feeds recording mediums P on a one-by-one basis from the load section that is loaded with a plurality of recording mediums P to the most upstream side conveyance cylinder 8. The conveyance cylinders 8, 8a, . . . convey a recording medium P to the transfer unit 4 at a time as they are driven to rotate. When the recording medium P is to be subjected to a double-sided recording operation, the conveyance cylinder 8a out of the conveyance cylinders 8, 8a, . . . turns upside down the recording medium P carrying an ink image recorded on one of the opposite surfaces thereof and sends it to the transfer cylinder 41. The chain 8c, which is an endless chain wound around a pair of sprockets 8b makes a circulating movement to convey the recording mediums (records P′) where ink images have been recorded to the collection unit 8d on a one-by-one basis. The records P′ are then loaded in the collection unit 8d.

<Post-Processing Units>

Post-processing units 10A, 10B are arranged downstream relative to the transfer unit 4. The post-processing unit 10A is a mechanism for executing a post-processing operation on the front surface of a record P′ and the post-processing unit 10B is a mechanism for executing a post-processing operation on the rear surface of the record P′. A post-processing operation refers to a coating operation (which may include liquid application, sheet welding, lamination, etc.) that is executed for the purpose of protecting the image on the image recording surface or on each of the image recording surfaces of a record P′ and polishing the surfaces thereof.

<Inspection Units>

Inspection units 9A, 9B are arranged downstream relative to the transfer unit 4. Each of the inspection units 9A, 9B is a mechanism that operates to take pictures of the images on records P′ and inspects the pictures. For instance, the inspection unit 9A takes pictures of the recorded images on recording mediums P during a series of recording operations that are being repetitively and successively executed, checks changes with time, if any, in the colors and other factors of the recorded images and determines if the image data or the recorded data on the recorded images need to be amended or not. On the other hand, the inspection unit 9B takes a picture of the image recorded in an experimental recording operation and operates to establish basic settings necessary for various amendment operations to be executed on the recorded data.

<Recording Operation>

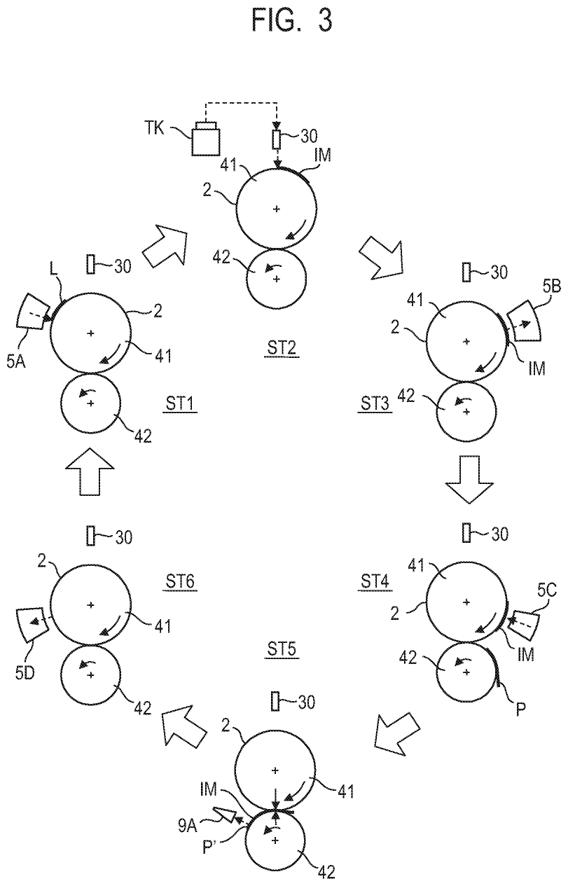

In the recording operation of this recording apparatus, the operation steps schematically illustrated in FIG. 3 are sequentially and cyclically executed while the transfer cylinder 41 and the impression cylinder 42 are being driven to rotate. More specifically, firstly, reaction liquid L is applied onto the transfer body 2 from the application unit 5A (ST1). As the transfer cylinder 41 revolves, the site where reaction liquid L is applied to the transfer body 2 gets to the position located vis-à-vis the recording heads 30. At this moment, liquid inks are ejected onto the transfer body 2 from the recording heads 30 and an image (ink image) IM is formed on the transfer body (ST2). At this time, as the ejected inks are mixed with the reaction liquid L on the transfer body 2, the agglomeration of the coloring materials is accelerated. Subsequently, as the transfer body 2 revolves, the ink image IM on the transfer body 2 gets to the position located vis-à-vis the absorption unit 5B and the absorption unit 5B contacts the transfer body 2 and absorbs the liquid component from the ink image IM (ST3). Thereafter, as the transfer body 2 revolves further and the ink image IM gets to the position located vis-à-vis the heating unit 5C, the ink image IM is heated by the heating unit 5C and the resin in the ink image IM is molten and turned to film (ST4). A recording medium P is brought in by the conveyance unit 1B in synchronism with the above-described operation of forming the ink image IM. As the ink image IM and the recording medium P simultaneously get to the nip section located between the transfer body 2 and the impression cylinder 42, the ink image IM is transferred onto the recording medium P (ST5). In this specification, a recording medium P onto which an ink image IM has been transferred is referred to as record P′. The transfer cylinder 41 and the impression cylinder 42 revolve further and the record P′ passes through the nip section. Then, at this time, a picture of the image that has been transferred onto the record P′ is taken by the inspection unit 9A for inspection. The record P′ is conveyed by the conveyance unit 1B to the collection unit 8d (see FIG. 1) and loaded in the collection unit 8d. Meanwhile, after the image transfer operation, the transfer cylinder 41 and the impression cylinder 42 keep on revolving and the surface area of the transfer body 2 where the ink image IM was formed gets to the position located vis-à-vis the cleaning unit 5D and is cleaned by the cleaning unit 5D (ST6). In this recording apparatus, the steps ST1 through ST6 are executed while the transfer body 2 makes a full turn. Thus, as the transfer body 2 makes a full turn for a number of times, the steps ST1 through ST6 are repeated so many times and so many ink images IM are transferred onto so many different recording mediums P. While an ink image IM is transferred onto a recording medium P during the time when the transfer body 2 makes a full turn in the above description for the purpose of easy understanding, it may alternatively be so arranged that a number of ink images IM are successively transferred onto so many recording mediums P during the time when the transfer body 2 makes a full turn.

<Absorption Unit>

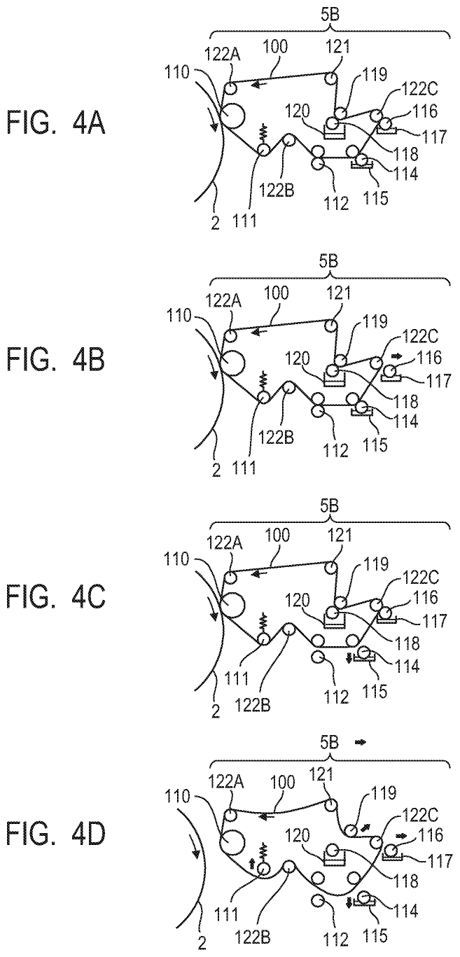

FIGS. 4A through 4D schematically illustrate the absorption unit 5B that is employed for the above-described operation of absorbing the liquid component from the ink image IM (ST3). At the absorption unit 5B, a liquid elimination sheet 100 in the form of an endless belt (endless belt sheet) is brought into contact with the transfer body 2 to absorb and eliminate the liquid component of the ink image on the transfer body 2. The endless belt-shaped liquid elimination sheet 100 is wound around and held by suspension rollers 122A through 122C and many other roller-shaped members. The many other roller-shaped members include a liquid elimination module 110, a tension module 111, a cleaning module 112, a liquid application module 114, a surfactant application module 116, a liquid recovery module 118, a pinch roller 119 and a meandering correction roller 121.

The liquid elimination module 110 is held in contact with the endless belt-shaped liquid elimination sheet 100 so as to keep the sheet 100 in contact with the transfer body 2 under pressure. While the shape of the liquid elimination module 110 is not subject to any particular limitations, it is preferably in the form of a roller as described above so that the liquid elimination sheet 100 may not be damaged as a result of frictional contact of the liquid elimination module 110 and the liquid elimination sheet 100. For the liquid elimination sheet 100 to be held in contact with the image on the transfer body 2 under pressure and satisfactorily absorb the liquid component from the image on the transfer body 2, the pressure applied to the liquid elimination sheet 100 to keep it in contact with the transfer body 2 under pressure is preferably not lower than 3 kgf/cm². The solid and the liquid of the image on the transfer body 2 can be separated from each other in a short period of time and the liquid component can satisfactorily be eliminated from the image when the is not lower than 3 kgf/cm². Note that this pressure is the nip pressure between the transfer body 2 and the liquid elimination sheet 100 and can be calculated by measuring the contact pressure by means of a contact pressure distribution measuring instrument (e.g., I-SC (trade name) available from NITTA CORPORATION) and dividing the weight value observed at the pressurized region by the area of the region. The pressurization time during which the liquid elimination sheet 100 is held in contact with the image on the transfer body 21 is preferably not longer than 50 ms in order to minimize adhesions of coloring materials (solid components) in contained in the image to the liquid elimination sheet 100. For the purpose of the present disclosure, the pressurization time can be determined by dividing the pressure sensing width of the transfer body 2 in the moving direction thereof as observed as a result of the above-described contact pressure measurement by the moving speed of the transfer body 2. The pressurization time is also referred to as liquid absorption nip time.

The tension module 111 operates to urge the liquid elimination sheet 100 to maintain its tension.

The cleaning module 112 operates to move away the small amount of coloring materials and the dust absorbed by the liquid elimination sheet 100 along with the liquid component from the image. The cleaning module 112 is desirably a roller formed by using sticky rubber such as silicon robber or butyl rubber.

The liquid application module 114 operates to supply application liquid 115 to the surface of the liquid elimination sheet 100 that has been cleaned by the cleaning module 112 in order to prevent the liquid elimination sheet 100 from drying and thickening the liquid it contains. As will be described hereinafter, the liquid elimination sheet 100 is made of a very fine porous material and therefore, if the solvent contained in the liquid component it has absorbed from the image dries, if partly, and the liquid component thickens in the porous material, the drying and the thickening can cause degradation of the absorption performance of the liquid elimination sheet 100. For this reason, application liquid 115 is supplied to prevent the liquid component from thickening. The main component of application liquid 115 may be pure water and contain isopropyl alcohol for the purpose of providing application liquid with an antifungal effect.

The liquid recovery module 118 and the pinch roller 119 pinch the liquid elimination sheet 100 and mechanically squeeze it to eliminate the unnecessary liquid component contained in the liquid elimination sheet 100. The removed liquid component (the recovered liquid 120) is held in the container placed below the liquid recovery module 118 and subsequently externally collected by way of a drain tube (not shown).

The meandering correction roller 121 is provided to control the attitude of the liquid elimination sheet 100 that is pinched by the liquid recovery module 118 and the pinch roller 119 and whose unnecessary liquid component has been eliminated and accurately feed the liquid elimination sheet 100 toward the transfer body 2.

The surfactant application module 116 is provided to execute a pre-processing operation of causing the liquid elimination sheet 100 to reliably absorb the liquid component. This pre-processing operation consists in applying a surfactant 117 to the liquid elimination sheet 100 when the recording apparatus is not operating for recording an image. At the initial operation stage that comes prior to a recording operation or each time when a predetermined number of sheets has been subjected to an image recording operation, the surfactant 117 is applied to the liquid elimination sheet 100. Then, as a result, the wettability of the surface of the liquid elimination sheet 100 is improved to make it possible to reliably and evenly recover liquid from the image. The surfactant 117 preferably contains water and a water-soluble organic solvent. The water to be contained in the surfactant 117 is preferably deionized water obtained by ion exchange. The type of the water-soluble organic solvent is not subject to any particular limitations. In other words, any known organic solvent such as ethanol or isopropyl alcohol may be used in the surfactant 117.

Now, how the absorption unit 5B having the above-described configuration operates will be described below. FIG. 4A illustrates how the members of the absorption unit 5B are held in contact with the endless belt-shaped liquid elimination sheet 100 and also the positional relationship of the members. When a recording operation is to be executed, the surfactant application module 116 is moved away from the liquid elimination sheet 100 as shown in FIG. 4B. On the other hand, when the recording operation is suspended and the surfactant 117 is applied to the liquid elimination sheet 100 by means of the surfactant application module 116, the surfactant application module 116 is brought into contact with the liquid elimination sheet 100 as shown in FIG. 4C. At this time, the cleaning module 112 and the liquid application module 114 are moved away from the liquid elimination sheet 100 and the operation of cleaning the liquid elimination sheet 100 and that of supplying the application liquid 115 to the liquid elimination sheet 100 are suspended.

During each recording operation, the unnecessary liquid component in the ink image that is formed on the transfer body 2 in Step ST2 is removed by the absorption unit 5B in Step ST3 as shown in FIG. 3. At this time, in the state as illustrated in FIG. 4B, pressure of a predetermined level is applied to the endless belt-shaped liquid elimination sheet 100, which is wound around the roller-shaped members and to which tension is applied by the tension module 111, by the liquid elimination module 110 to bring the liquid elimination sheet 100 into contact with the transfer body 2 under the applied pressure. The surfactant 117 has already been applied to the surface of the liquid elimination sheet 100 that contacts the transfer body 2, by the surfactant application module 116. Thus, as a result, the liquid elimination sheet 100 satisfactorily absorbs and eliminates the unnecessary liquid component in the image on the transfer body 2. The coloring materials and the dust contained in the liquid component absorbed by the liquid elimination sheet 100 are recovered by the cleaning module 112. Subsequently, application liquid 115 is supplied to the cleaned surface of the liquid elimination sheet 100 by the liquid application module 114 to prevent the liquid component from drying and thickening. Thereafter, the unnecessary liquid component contained in the liquid elimination sheet 100 is recovered by means of the liquid recovery module 118 and the pinch roller 119. At this time, since the surfactant application module 116 has been moved away from the liquid elimination sheet 100 as shown FIG. 4B and hence the operation of applying the surfactant 117 has been suspended. Then, the liquid elimination sheet 100, from which the coloring materials, the dust and the unnecessary liquid component have been removed, is brought into contact with the transfer body 2 once again in the above-described manner to remove the unnecessary liquid component in the ink image. The endless belt-shaped liquid elimination sheet 100 makes a circulating movement in a manner as described above while an operation of recording images on a plurality of recording mediums P as shown in FIG. 3 is being executed so that the unnecessary liquid component in the ink image on the transfer body 2 is removed to realize a satisfactory image transfer operation. As a result of eliminating the unnecessary liquid component in the ink image on the transfer body 2, any situation where the ink on a recording medium P excessively contains the liquid component is prevented from taking place and hence appearances of phenomena such as curling and cockling can effectively be minimized.

Now, the operation of replacing the endless belt-shaped liquid elimination sheet 100 will be described below by referring to FIG. 4D. When replacing the liquid elimination sheet 100, the cleaning module 112, the liquid application module 114 and the surfactant application module 116 are all moved away from the liquid elimination sheet 100 such that these modules would never touch the liquid elimination sheet 100 during the operation of replacing the liquid elimination sheet 100. Additionally, the tension roller 111 and the pinch roller 119 are forced to retreat from the liquid elimination sheet 100 such that the liquid elimination sheet 100 is released from the tension that has been applied to it so as to get into a loosened state. With these arrangements, the liquid elimination sheet 100 is made ready for replacement and an operation of accessing the recording apparatus from the front side thereof and replacing the liquid elimination sheet 100 is executed in this state.

<Liquid Elimination Sheet>

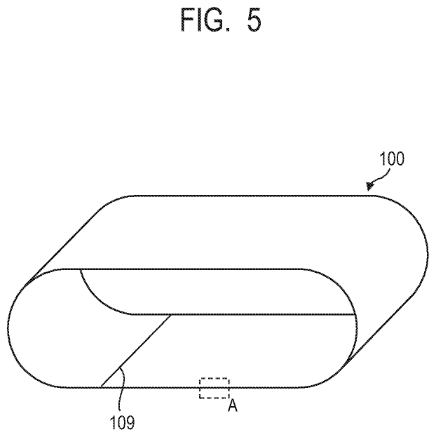

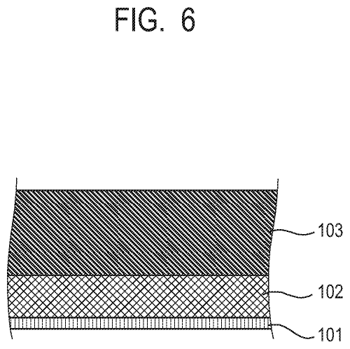

FIG. 5 shows how the endless belt-shaped liquid elimination sheet 100 externally appears and FIG. 6 shows an enlarged schematic cross-sectional view of part A shown in FIG. 5. Since the liquid elimination sheet 100 is a porous body and brought into direct contact with the image on the transfer body 2 in the operation of eliminating the liquid component from the image, it is required to minimize adhesions of coloring materials (solid components) to it. For this reason, the liquid elimination sheet 100 preferably shows a small pore size. The pore size of the porous body at the side thereof that is to be brought into contact with the image on the transfer body 2 is preferably not more than 10 μm. Note, however, the pore size of the rear surface (the surface that is not brought into contact with the transfer body 2) of the liquid elimination sheet 100 does not need to be particularly small. When the recovery efficiency of the step where the liquid component absorbed by the liquid elimination sheet 100 is recovered by means of the liquid recovery module 118 and the pinch roller 119 is put into consideration, the pore size of the rear surface of the liquid elimination sheet 100 may rather be large. This is because, if the pore size of the liquid elimination sheet 100 is small both at the front surface and at the rear surface, any liquid movement in the inside of the liquid elimination sheet 100 is obstructed by flow resistance. Note that the expression of “pore size” as used herein refers to the average pore diameter, which can be observed typically by means of a mercury injection method, a nitrogen adsorption method or an SEM image observation method.

Additionally, the thickness of the liquid elimination sheet 100 (porous body) is preferably small from the viewpoint of securing a uniform and high breathability. The breathability of an object can be expressed by means of a Gurley value as defined in JIS P8117. The Gurley value of the liquid elimination sheet 100 is preferably not greater than 10 seconds. While the liquid elimination sheet 100 is ideally a seamless perfect endless belt, it may be an endless belt having a junction 109 as shown in FIG. 5. When the liquid elimination sheet 100 has a junction 109, the circulating movement of the liquid elimination sheet 100 is preferably synchronized with the movement of the image on the transfer body 2 so that the junction 109 would never contact the image.

When securing rigidity and strength for the entire liquid elimination sheet 100 is taken into consideration, the liquid elimination sheet 100 desirably has a multilayer structure as shown in FIG. 6. FIG. 6 is an enlarged schematic cross-sectional view of part A in FIG. 5. Now, a liquid elimination sheet 100 having a three-layered structure as shown in FIG. 6 will be described below.

[First Layer]

The outermost layer, which is the layer to be brought into contact with the transfer body 2, of the liquid elimination sheet 100 of the recording apparatus is referred to as the first layer 101. The material of the first layer 101 is not subject to any particular limitations and may be either a hydrophilic material whose contact angle relative to water is less than 90° or a hydrophobic material whose contact angle relative to water is not less than 90°. When the first layer 101 is made of a hydrophilic material, its contact angle relative to water is preferably not greater than 40°. When the first layer 101 is made of a hydrophilic material, it will provide an effect of sucking up liquid by capillary force. As hydrophilic material, a single material such as cellulose or polyacrylamide or a composite material prepared by using such single materials may appropriately be selected.

Alternatively, the surface of a hydrophobic material may be subjected to a hydrophilization treatment so as to be used for the first layer 101. The material of the first layer 101 is preferably a hydrophobic material showing low surface free energy, a fluorine resin material in particular, from the viewpoint of minimizing adhesion of coloring materials and achieving a high cleaning effect. Specific examples of fluorine resin materials that can be used for the first layer 101 include polytetrafluoroethylene (PTFE), polychlorotrifluoro ethylene (PCTFE), polyvinylidene fluoride (PVDF), polyvinyl fluoride (PVF), perfluoroalkoxy alkanes (PFA), fluorinated ethylene propylene copolymers (FEP), ethylene.tetrafluoroethylene copolymers (ETFE) and ethylene chlorotrifluoroethylene copolymers (ECTFE). If necessary, two or more than two of the above-listed materials may be used in combination. The first layer 101 per se may have a multilayer structure. Hydrophilization techniques that can be used for the purpose of the present disclosure include sputter etching, irradiation of radioactive rays or H₂O ions and excimer (UV) laser beam irradiation. When the first layer 101 is made of a hydrophobic material, it practically does not show any effect of sucking up the aqueous liquid component by capillary force and may consume time to suck up the aqueous liquid component when it is brought into contact with the image on the transfer body 2 for the first time. For this reason, the first layer 101 is preferably immersed with liquid that shows a contact angle of less than 90° relative to the first layer 101. The liquid with which the first layer 101 is immersed is referred to as wetting liquid and preferably prepared by mixing water with a surfactant or some other liquid that shows a low contact angle relative to the first layer 101. The first layer 101 can be immersed with such wetting liquid by applying the wetting liquid to the surface of the first layer 101.

The thickness of the first layer 101 of the liquid elimination sheet 100 of this recording apparatus is preferably not greater than 50 μm and more preferably not greater than 30 μm. For the purpose of the present disclosure, the film thickness of the first layer 101 is determined by observing the film thickness of the first layer 101 at arbitrarily selected ten points by means of a straight forward type micrometer (OMV-25 (trade name) available from Mitsutoyo) and calculating the average of the observed values.

The first layer 101 can be prepared by any known method of manufacturing thin and porous films. For example, the first layer 101 can be obtained by molding any of the above-described resin materials into a sheet by means of extrusion molding or the like and stretching the product until it comes to show a predetermined thickness. Furthermore, paraffin or some other plasticizer may be added to the material to be subjected to extrusion molding and the plasticizer may be removed by heating at the time of stretching to produce a porous film. The pore size of the porous film can be adjusted by adjusting the rate at which the plasticizer is added and/or by adjusting the stretching ratio.

[Second Layer]

The second layer 102 of the liquid elimination sheet 100 of this recording apparatus is preferably a relatively rough layer that shows a small flow resistance. The second layer 102 may be prepared by means of nonwoven fabric of resin fibers or woven fabric. While the material of the second layer 102 is not subject to any particular limitations, it is preferably a material showing a contact angle relative to water that is equal to or lower than the contact angle relative to water of the first layer 101 so that the liquid absorbed by the second layer 102 may not flow back into the first layer 101. Specific examples of materials that can be used for the second layer 102 include poly olefins (such as polyethylene (PE) and polypropylene (PP)), polyamides such as polyurethane and nylon, polyesters (such as polyethylene terephthalate (PET)) and polysulfones (PSF). Any of the above-listed materials may preferably be employed as a single material or a composite material. Additionally, the second layer 102 is preferably a porous body whose pore size is greater than the pore size of the first layer 101. The use of a polyolefin for the second layer 102 is particularly preferable because the second layer 102 made of a polyolefin can easily be bonded to the first layer 101 by way of thermal lamination. The film thickness of the second layer 102 is preferably not greater than 300 μm.

[Third Layer]

The liquid elimination sheet 100 does not necessarily require the third layer 103 if the first layer 101 and the second layer 102 can satisfactorily secure the rigidity and the strength of the liquid elimination sheet 100. However, if the second layer 102 is made of a material such as polyolefin that can easily be bonded to the first layer 102 by way of thermal lamination, the liquid elimination sheet 100 preferably has the third layer 103 from the viewpoint rigidity and strength. The third layer 103 may also preferably be prepared by means of nonwoven fabrics from the viewpoint of aeration and rigidity. Specific examples of materials that can be used for the third layer 103 include polyamides, polyesters (such as polyethylene terephthalate (PET)) and polysulfones (PSF). Any of the above-listed materials may preferably be employed as a single material or a composite material. Additionally, the thickness of the third layer 103 is preferably not greater than 500 μm.

(Method of Laminating Porous Bodies)

The method of laminating a plurality of porous bodies in order to form the liquid elimination sheet 100 having a multilayer structure as described above is not subject to any particular limitations. For example, the porous bodies of the first through third layers 101 through 103 may be bonded to each other by way of adhesive lamination or thermal lamination. However, from the viewpoint of aeration, the porous bodies are preferably bonded to each other to form the liquid elimination sheet 100 of this recording apparatus by way of thermal lamination. Alternatively, for example, the first layer 101 and the second layer 102 may be heated until they are partially molten and then bonded to each other. Still alternatively, a fusion bonding agent such as hot melt powder may be put between the first layer 101 and the second layer 102 and then the first layer 101 and the second layer 102 may be bonded to each other by heating the fusion bonding agent. In any of the above-described heating operation, preferably the layers (porous bodies) are pinched by heated rollers under pressure such that they are bonded to produce a multilayer structure by heat and under pressure. When the third layer 103 and one or more additional layers are laid on the first and second layers 101 and 102, all the layers may be bonded at a time or may alternatively be bonded sequentially. The order in which the layers are bonded sequentially may appropriately be determined.

<Protection Members of Liquid Elimination Sheet>

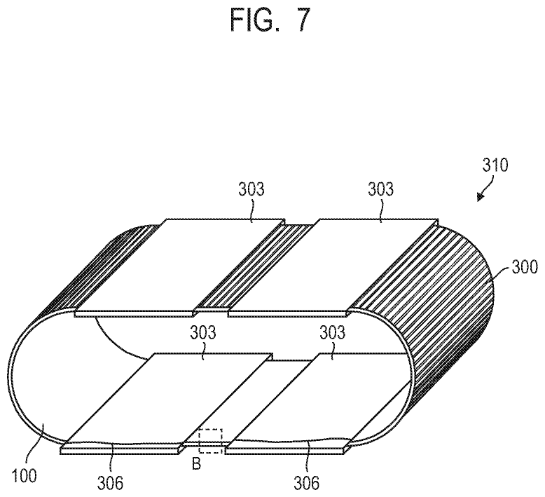

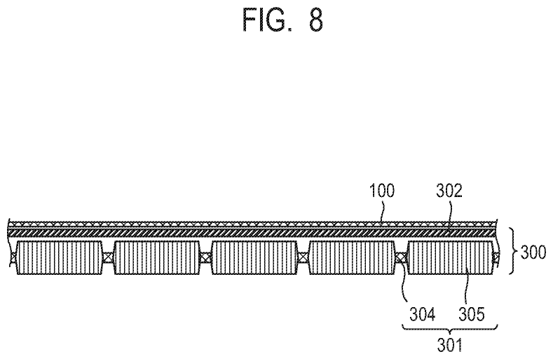

The surface of the above-described liquid elimination sheet 100 can easily be damaged. Additionally, since the surface is brought into direct contact with the image on the transfer body 2 in order to eliminate the liquid in the image, if a slight scar is produced on the surface of the liquid elimination sheet 100, it can adversely affect the quality of the image. In short, it is very important to protect the surface of the liquid elimination sheet 100. For this reason, a protection member (protective sheet) 300 having a multilayer structure is employed in order to protect the surface (the surface to be protected) of the liquid elimination sheet 100. More specifically, as shown in FIGS. 7 and 8, firstly the surface of the liquid elimination sheet 100 is covered by a soft material 302 and then the soft material 302 is covered by a hard material 301. Thus, an endless belt laminate is formed by laying the protective sheet 300 on the liquid elimination sheet 100 in the above-described manner. The soft material 302, which is brought into direct contact with the surface of the liquid elimination sheet 100 to cover the surface thereof and hence constitutes the inner layer (the contact layer), may typically be made of soft rubber or a sponge-like porous body. Examples of soft rubber for covering the surface of the liquid elimination sheet 100 include acrylonitrile-butadiene rubber, acrylic rubber, chloroprene rubber, urethane rubber and silicon rubber. Examples of sponge-like porous body include a porous rubber material prepared by mixing any of the above-listed rubber materials with a vulcanizing agent or a vulcanization accelerator to a predetermined ratio at the time of molding the rubber material and, if necessary, adding a foaming agent and/or a filler material such as hollow micro particles or salt. Still alternatively, the surface of the liquid elimination sheet 100 may be covered by a sponge formed by causing polyethylene, acryl-based resin or the like to foam and molding it to a predetermined shape. A sponge-like porous material can disperse the pressure applied to the liquid elimination sheet 100 and effectively prevent the sheet 100 from being damaged, because the pores, or the bubble-like cavities, thereof are compressed under pressure to reduce their volume and accommodate pressure fluctuations. As for the structure of the rubber material of the porous body, the pores may be arranged continuously to produce a continuous pore structure or alternatively arranged independently to produce an independent pore structure. Still alternatively, these two structures may be combined for use.

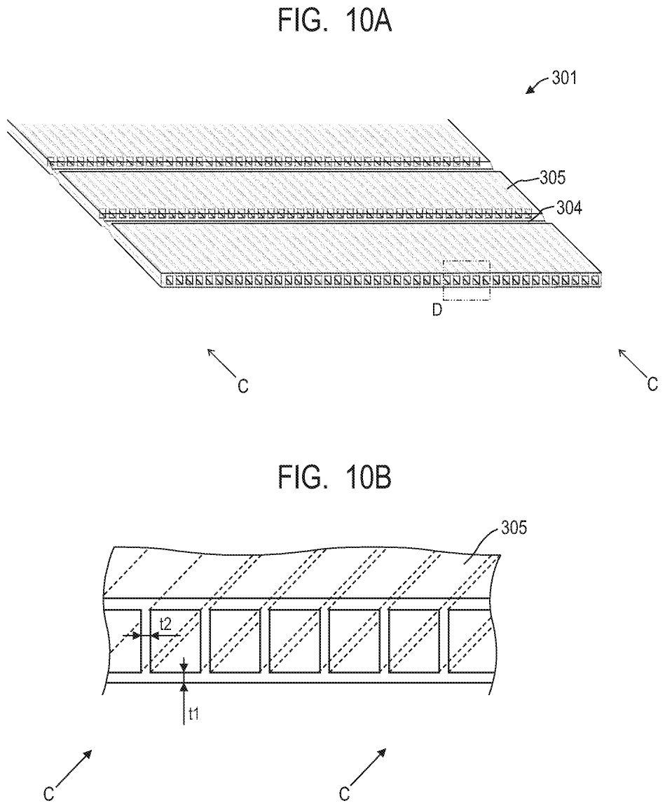

The hard material 301 that is the outer layer part (noncontacting side layer) arranged at the outside (on the outer peripheral surface) of the soft material 302 (contacting side layer) and hence at the side opposite to the side of the surface of the soft material 302 that is to be brought into contact with the surface to be protected of the liquid elimination sheet 100 is desirably highly rigid. However, when the liquid elimination sheet 100 is mounted in the apparatus main body, it needs to be deformed so as to adapt itself to the profile of the sheet path (the route of the circulating movement), which will be described hereinafter. For this reason, the rigidity of the liquid elimination sheet 100 in the circumferential direction (the direction of the circulating movement, the feeding direction which may also be referred to as longitudinal direction) needs to be reduced to secure the deformability of the liquid elimination sheet 100 in the circumferential direction. Therefore, the outer hard material 301 preferably shows a high bending stiffness in the width direction that orthogonally intersects the circumferential direction of the liquid elimination sheet 100 and a low bending stiffness in the circumferential direction. Therefore, the outer hard material 301 of the protective sheet 300 of this recording apparatus is formed by alternately arranging pieces of a high rigidity material 305 and pieces of a low rigidity material 304 in the circumferential direction as shown in FIGS. 8 through 11D. The high rigidity material 305 may be selected from various resin materials such as polypropylene, acryl, ABS resin and vinyl chloride and wood. Any of these materials may be used as bulk material (solid material) or the material to be used may be turned into a light weight material by forming cavities in the inside like a foamed material or a material having a cardboard-like structure (see FIGS. 10A and 10B). On the other hand, the low rigidity material 304 may be selected from rubber materials such as acrylonitrile-butadiene rubber, acrylic rubber, chloroprene rubber, urethane rubber and silicon rubber. Alternatively, the low rigidity material 304 may be formed by using a material selected from various resin materials such as polypropylene, acryl, ABS resin and vinyl chloride that can be employed as the high rigidity material 305 and reducing the thickness of the pieces of the selected material. Then, the material 301 prepared by alternately arranging pieces of a high rigidity material 305 and pieces of a low rigidity material 304 in the circumferential direction is arranged outside the above-described soft material 2. Thus, any local force that is externally applied is received by a large area and the stress is dispersed to make it possible to minimize any potential damages to the liquid elimination sheet 100. Note, however, when the bending stiffness of the liquid elimination sheet 100 in the circumferential direction is reduced, curved parts of the liquid elimination sheet 100 can become bent and damaged. Therefore, the radius of curvature of any curved part is desirably controlled by making the pieces of the high rigidity material 305 and those of the low rigidity material 304 show respective thicknesses that differ from each other. The expression of the circumferential direction of the sheet as used herein is not limited to that of an endless belt sheet showing a circular or oblong lateral view and may be that of an endless belt sheet showing a lateral view of any closed loop and the circumferential direction refers to the direction in which the endless belt sheet extends and hence the direction in which the endless belt sheet moves around.

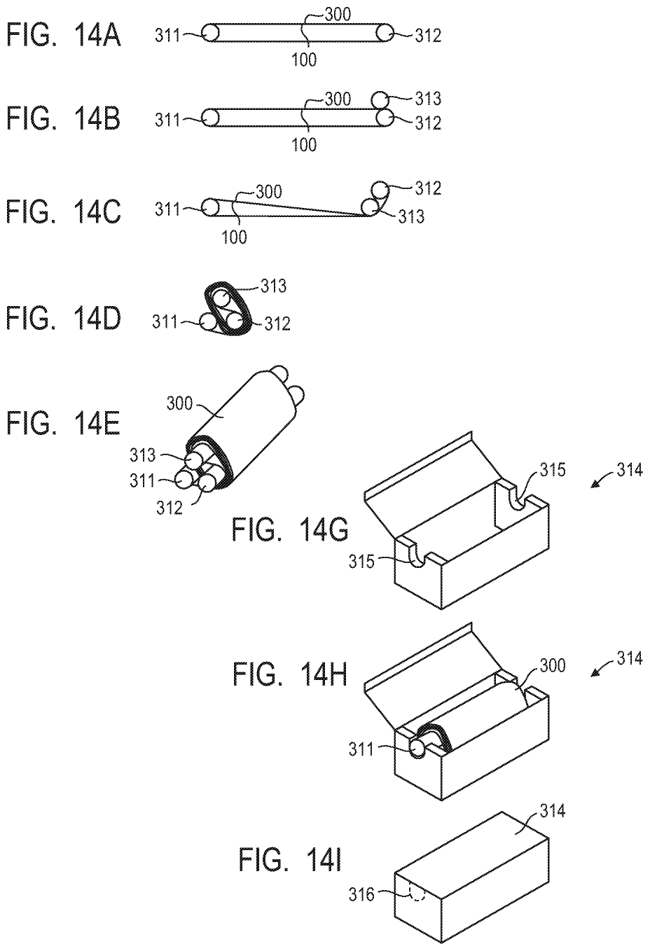

For the purpose of binding the laminate type protective sheet 300 and the laminate type liquid elimination sheet 100 together to produce an integrated unit, binder sheets (binding members) 303 as shown in FIG. 7 are tightly bound around the protective sheet 300 and the liquid elimination sheet 100 to produce a cartridge-like unit. Thus, the liquid elimination sheet 100 is held in the cartridge and mounted in the apparatus main body. As will be described in greater detail hereinafter, the cartridge is made compact and contained in a packing box 314 to produce a package that can be conveyed and stored with ease as shown in FIGS. 14H and 14I.

<Liquid Elimination Sheet Mounting Method>

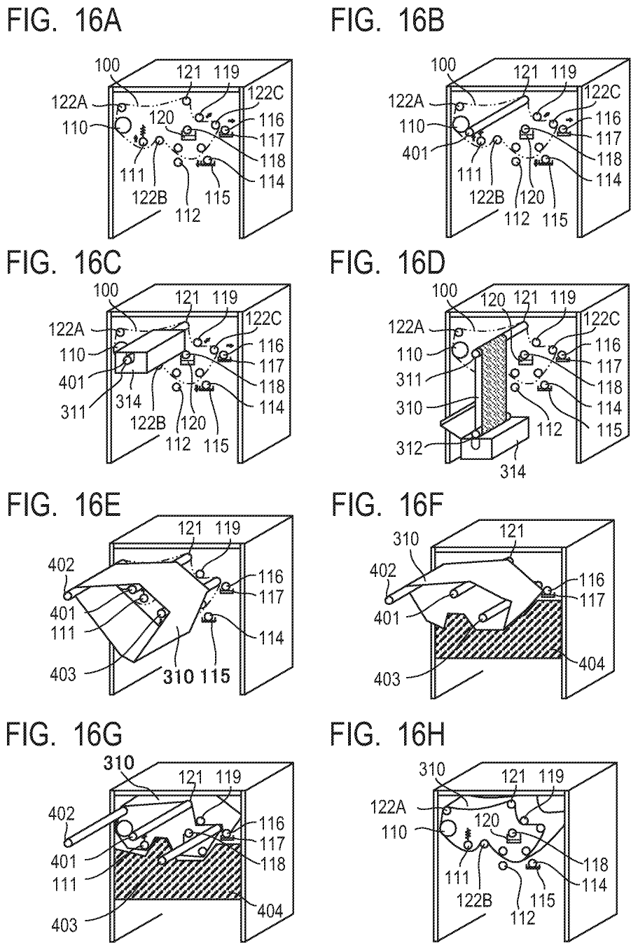

Various members as shown in FIGS. 4A through 4D are arranged in the apparatus main body, into which the liquid elimination sheet 100 is to be mounted. Thus, the liquid elimination sheet 100 is required to make a circulating movement, weaving its way through these members. In other words, the route of the circulating movement of the liquid elimination sheet 100 (sheet path) is a narrow and complicated one. When the liquid elimination sheet 100 is mounted into the apparatus main body, the liquid elimination sheet 100 is required to adapt itself to this narrow and complicated sheet path in order to properly get into the apparatus main body. When the apparatus is a large one, where the apparatus main body and the sheet path are also large, and the cartridge is made to show a rigid profile that matches the sheet path, the cartridge will become a huge one that is not adapted to easy conveyance and easy storage. For this reason, a cartridge is formed for this recording apparatus by using a flexible protection member as described above. More specifically, the liquid elimination sheet 100 is covered by the protective sheet 300 and put into a deformable cartridge for this recording apparatus. As will be described in greater detail hereinafter, when the liquid elimination sheet 100 is mounted into the apparatus main body, the cartridge is deformed so as to adapt itself to the sheet path as shown in FIGS. 16A through 16H. The cartridge 310 is taken out of the packing box 314 and then deformed to match the sheet path by means of the assist rods (profiling rods) arranged at an upper part and the guide plate arranged at a lower part of the apparatus main body or the mounting jig. Then, the liquid elimination sheet showing a profile similar to that of the sheet path is then put into the apparatus main body and mounted in position.

<Other Recording Apparatus>

While the recording unit 3 of the above-described recording apparatus has a plurality of recording heads 30, the recording unit may alternatively be so designed as to have only a single recording head 30. The recording head 30 may not necessarily be a full line head and may alternatively be a serial type head that is to be driven to move in the Y-direction for a scanning operation of forming an ink image. The conveyance mechanism 1B for conveying recording mediums P may be of the type of pinching and conveying a recording medium P by means of a pair of rollers or of some other type. When the conveyance mechanism 1B of the type of conveying a recording medium P by means of a pair of rollers is adopted, a paper roll may be used for the recording medium P and the paper roll may be cut to produce a record P′ after the image on the transfer body 2 is transferred to the paper roll.

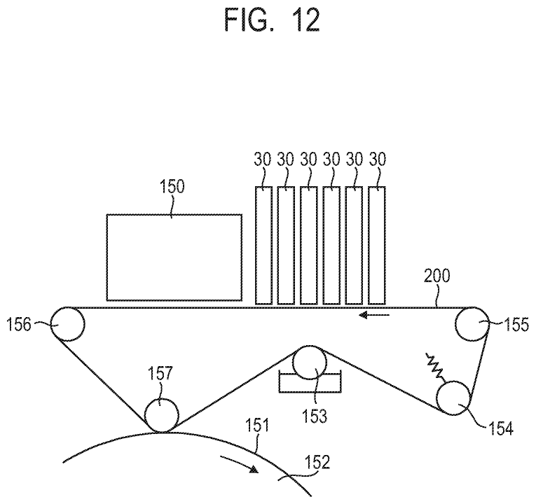

In the above-described recording apparatus, the transfer body 2 is arranged on the outer peripheral surface of the transfer cylinder 41, a transfer body of some other type, for example of the type with which the transfer body 2 is realized in the form of an endless belt and driven to make a circulating movement may alternatively be adopted. FIG. 12 schematically illustrates a recording apparatus in which a belt-shaped transfer body is employed and to which the present disclosure is applicable. In this recording apparatus, an image is recorded on the belt-shaped transfer body 200 by means of recording heads 30 and, after the liquid component of the recorded image is driven off by a dryer heater 150, the image is transferred onto a recording sheet 151 placed on a conveyance roller 152 by means of a nip roller 157. The belt-shaped transfer body 200 is suspended by suspension rollers 155, 156 and pressed against a recording sheet 151 by the nit roller 157. Thereafter, the belt-shaped transfer body 200 is cleaned by a cleaning roller 153 to eliminate the coloring materials and the dust that are left untransferred on the transfer body 200. The tension of the belt-shaped transfer body 200 is controlled by a tension roller 154. When replacing the belt, the tension roller 154 is moved away from the belt-shaped transfer body 200 to loosen the belt-shaped transfer body 200 and allow it to be pulled frontward from the apparatus main body. Then, the belt-shaped transfer body 200 can be replaced with ease. While any of the materials cited for the transfer body 2 of the above-described recording apparatus may also be used for the belt-shaped transfer body 200, a silicon rubber-based material, which has flexibility and heat resistance property, may desirably be used for the belt-shaped transfer body 200 when the fact that it is forcibly curved and heated by a dryer heater is taken into consideration. The belt-shaped transfer body 200 will be covered by a protective sheet similar to the protective sheet 300 shown in FIGS. 7 through 10B and put into a cartridge.

### EXAMPLES

Now, the present disclosure will be described further in greater detail by way of examples. Note, however, that the scope of the present disclosure is by no means limited by the examples that will be described hereinafter unless the spirit of the present disclosure is disregarded.

### Example 1

(Structure of Cartridge)

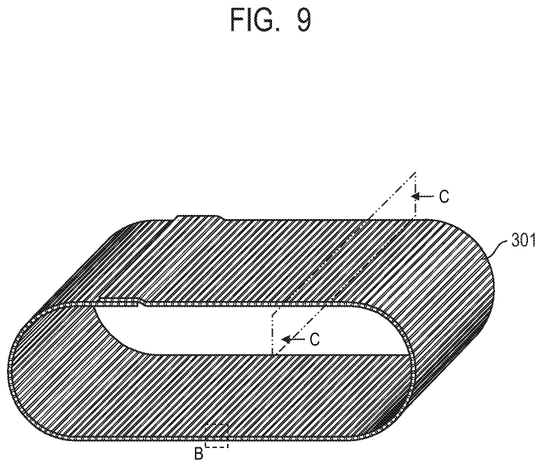

FIG. 7 shows the cartridge 310 of Example 1 of this disclosure. As shown in FIG. 7, the protection member (protective sheet) 300 is wound around the outer peripheral surface of the liquid elimination sheet 100 and the protective sheet 300 and the liquid elimination sheet 100 are rigidly held together as the binding sheets 303 are bound around them. As shown in FIG. 8, the protective sheet 300 has a multilayer structure formed by an inner layer (contacting side layer) of a soft material (cushion material) 302 and an outer layer (noncontacting side layer) of a hard material (shell) 301. The cushion material 302 that is held in direct contact with the outer peripheral surface (surface to be protected) of the liquid elimination sheet 100, which is to be brought into direct contact with the image on the transfer body 2, is made of a soft material such as polyethylene-made foamy sponge (and has a thickness of 2 mm). The shell 301 arranged outside the cushion material 302 is made to show a low bending stiffness in the circumferential direction of the liquid elimination sheet 100 but show a high bending stiffness in the width direction that is orthogonal relative to the circumferential direction from the viewpoint of making the operation of mounting the cartridge in the apparatus main body an easy one and preventing the cartridge from becoming a large one. If the bending stiffness of the protective sheet 300 is same and constant in all directions, the liquid elimination sheet 100 will freely be curved in all directions and can easily give rise to bents during the operation of mounting the cartridge in the apparatus main body. However, since the bending stiffness of the shell 301, in particular, is differentiated between the circumferential direction and the width direction, the directions in which the shell 301 can easily be curved are limited and hence the shell 301 will hardly and unnecessarily be curved (and bent) when it is mounted in the apparatus main body so that it will hardly be damaged. As shown in FIG. 8, the shell 301 is formed by alternately arranging low rigidity parts (parts showing a relatively low rigidity and a relatively high flexibility) 304 and high rigidity parts (parts showing a relatively high rigidity and a relatively low flexibility) 305 and hence anisotropic in terms of rigidity. While the shell 301 and the cushion material 302 may be bonded to each other, they are preferably simply laid one on the other without being bonded to each other from the viewpoint of flexibility required at the time of mounting the cartridge into the apparatus main body. As shown in FIG. 9, the sheet-like member of the shell 301 is rounded and their ends (unfixed ends) are laid one on the other without being rigidly secured to an intermediate part thereof.

The cushion material 302 and the shell 301 are sequentially laid on the outer peripheral surface of the liquid elimination sheet 100 and these members are collectively rigidly bound by binding sheets 303. The binding sheets 303 cover the members that are laid one on the other and bind them together. In other words, the members that are laid one on the other are not held unmovable relative to each other by means of an adhesive agent or the like. As will be described in greater detail hereinafter, in the operation of mounting the liquid elimination sheet 100 into the apparatus main body, after the cartridge 310 is mounted in the apparatus main body, the binding sheets 303 are taken out from the apparatus main body, while the liquid elimination sheet 100, the cushion material 302 and the shell 301 are left in the apparatus main body. For this reason, the binding sheets 303 are desirably slippery sheets such as polyethylene-made sheets. In this example, a total of four binding sheets are provided and arranged at so many separate positions as shown in FIG. 7. If the liquid elimination sheet 100 is separated from the cushion material 302 and the shell 301 before the liquid elimination sheet 100 is mounted in the apparatus main body, the bend minimizing effect of the shell 301 is lost and the liquid elimination sheet 100 will be bent and damaged with ease. Therefore, the binding sheets 303 are employed to prevent these members from being separated from each other and the liquid elimination sheet 100 from being bent and damaged. The binding sheets 303 are desirably selectively arranged at positions where the liquid elimination sheet 100 and the shell 301 can easily be separated from each other during the operation of mounting the liquid elimination sheet 100 into the apparatus main body because of the positional relationship between the liquid elimination sheet 100 and the shell 301 and the related rollers of the apparatus main body. Provided that the binding sheets 303 can be removed with ease after the liquid elimination sheet 100 is mounted in the apparatus main body, the binding sheets 303 are desirably made to cover the entire inner surface of the liquid elimination sheet 100.

In order to make the binding sheets 303 easily removable from the apparatus main body after mounting the cartridge 310 into the apparatus main body, each of the binding sheets 303 is provided with an easy tear off part 306. The easy tear off part 306 may be a part that can trigger breaking of a sheet or a tape such as a tape popularly referred to as “a tear tape” or may be a sticky part of a poorly sticky tape. Regardless of the making of the easy tear off parts 306, they are desirably arranged on the inner peripheral parts of the cartridge 310 so that the easy tear off parts can easily be torn off and the binding sheets 303 can easily be removed from the apparatus main body after mounting the cartridge 310 into the apparatus main body.

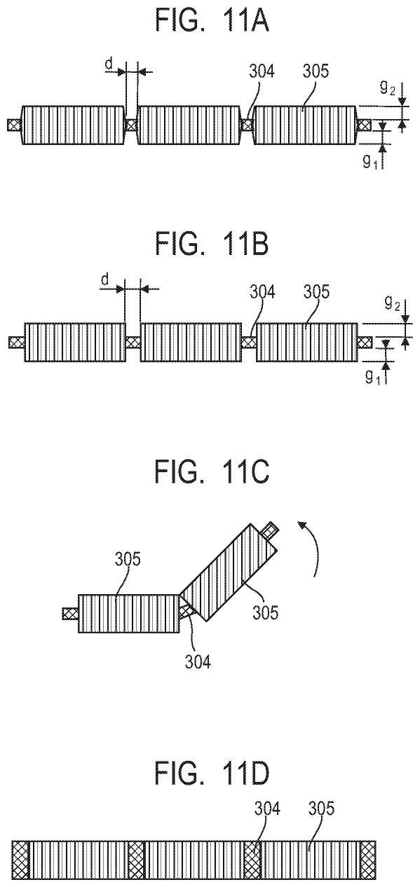

As described above, the shell 301 includes low rigidity parts 304 and high rigidity parts 305 and it is advantageous to make the low rigidity parts 304 show a thickness smaller than that of the high rigidity parts 305 as shown in FIGS. 11A and 11B from the viewpoint of limiting the extent of curving of the liquid elimination sheet 100 in the circumferential direction of the liquid elimination sheet 100. Additionally, an arrangement where the low rigidity parts 304 are located inside relative to the high rigidity parts 305, namely an arrangement where the low rigidity parts 304 have a thickness smaller than that of the high rigidity parts 305 and each of the low rigidity parts 304 is located between the oppositely disposed ends of two neighboring high rigidity parts 305 as viewed in the thickness direction is desirable. With such an arrangement, two neighboring high rigidity parts 305 interfere with each other when the shell 301 is curved as shown in FIG. 11C. Then, as a result, the extent of curving of the shell 301 is limited and the risk of bending of the liquid elimination sheet 100 can be minimized. The extent to which shell 301 can be curved can appropriately be determined depending on the rigidity and the strength of the liquid elimination sheet 100. However, the low rigidity parts 304 and the high rigidity parts 305 may have the same thickness as shown in FIG. 11D and the difference of rigidity between the low rigidity parts 304 and the high rigidity parts 305 may be realized by using different materials for them.

The shell 301 of this example was formed by using a plastic cardboard that is made of polyolefin (“Pladan”, trade name, available from YAMAKO). In this example, the low rigidity parts 304 were produced by subjecting a plastic cardboard Pladan to partial thermal compression (by heating and melting) of the cardboard at regular intervals to reduce thickness and the rigidity of the thermally compressed parts. Note that the low rigidity parts 304 and the high rigidity parts 305 are resin-made members that are made of a same material. The liquid elimination sheet 100 of this example was 810-mm wide and peripherally about 2.8-m long. The shell 301 was made to have a length of about 3 m to make it match the length of the liquid elimination sheet 100. The plastic cardboard used in this example was a resin member having a structure where many walls having a thickness of t2 were arranged between two plates having a thickness of t1 as shown in FIG. 10B. Due to the structure, the plastic cardboard was highly rigid and strong against any effort of curving it in the direction of arrow C. However, because of the restrictions inherent to the method of manufacturing it, it was not possible to produce a cardboard having a large length in the C direction. For this reason, thermally molten parts were formed at regular intervals in the starting material having a large length in the C direction as shown in FIG. 10A, thereby producing the low rigidity parts 304. Of the shell 301 of this example, each of the high rigidity parts 305 had a thickness of 3 mm and a length of about 30 mm and each of the low rigidity parts 304 had a thickness of 0.2 mm and a length of about 2 mm.

(Packing of Cartridge)

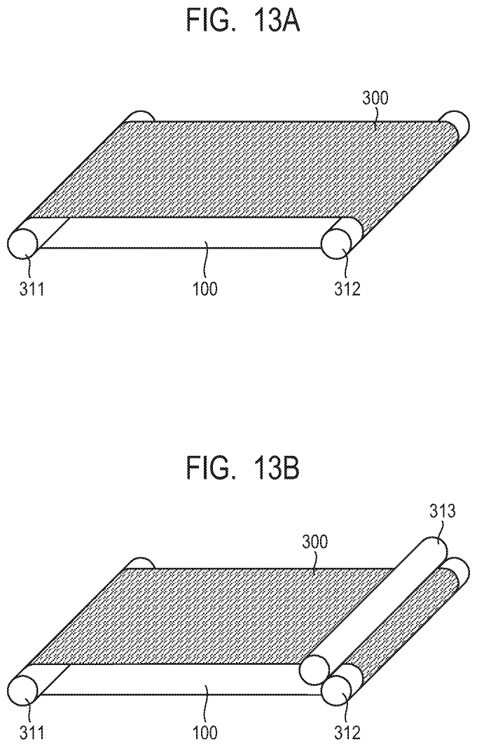

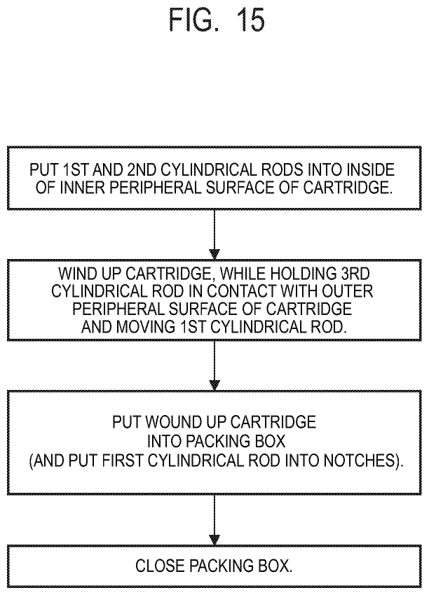

Now, how the cartridge 310 is packed for the purpose of delivery will be described by referring to FIGS. 13A and 13B, 14A through 14I and 15. For the purpose of transportation and storage, the cartridge 310 is required to be packed as compactly as possible without damaging the liquid elimination sheet 100. As described above, the cartridge 310 is can be curved. Firstly, as shown in FIGS. 13A and 14A, the first take-up cylindrical rod 311 and the second take-up cylindrical rod 312 are put into the inside of the cartridge 310 at opposite ends thereof such that slight tension is applied to the cartridge 310. Then, as shown in FIGS. 13B and 14B, the third cylindrical rod (shaft) 313 is placed on the cartridge 310 from outside. The third cylindrical rod 313 placed on the cartridge 310 from outside and the second cylindrical rod (one of the shafts in the inside) 312 in the inside of the cartridge 310 are placed side by side with a part of the cartridge 310 interposed between them. Thereafter, as shown in FIG. 14C, the cartridge 310 is wound around the third cylindrical rod 313 and the second cylindrical rod 312. As the cartridge 310 is wound on, the first cylindrical rod 311 is moved to come close to the second and third cylindrical rods 312, 313. Then, as shown in FIGS. 14D and 14E, the cartridge 310 is wound around the second and third cylindrical rods 312, 313, which are placed side by side with a part of the cartridge 310 interposed between them, for several times and the first cylindrical rod 311 is held close to the second and third cylindrical rods 312, 313 with a part of the wound cartridge 310 interposed between them. The long cartridge 310 is compacted in the above-described manner. Note that the third cylindrical rod 313 may alternatively be placed close not only to the second cylindrical rod 312 but to the first cylindrical rod (the other shaft in the inside) 311 with a part of the cartridge 310 interposed between them such that the cartridge 310 is wound around the third cylindrical rod 313 and the first cylindrical rod 311 for several times.

Subsequently, the cartridge 310 that has been compacted as shown in FIG. 14E is put into a packing box 314 as shown in FIG. 14G. The opposite ends of the first cylindrical rod 311 are respectively put into engagement with the notches 315 formed in the packing box 314 so as to be rigidly held there (see FIG. 14H). Then, the lid of the packing box 314 is closed to complete the operation of producing a package as shown in FIG. 14I. In this example, the rigidly secured first cylindrical rod 311 is recognizable from the outside of the packing box 314 and the packing box 314 is provided with easy open parts 316 such that holes can easily be produced at positions that respectively correspond to the notches 315. While the packing box 314 may be made of a resin material, it is desirably made of cardboard because cardboard is less expensive and lightweight. The easy open parts 316 are desirably indicated by cut lines formed on the cardboard of the packing box 314. The packing box 314 may be provided with parts (e.g., notches) for rigidly securing the second cylindrical rod 312 and the third cylindrical rod 313. From the viewpoint of the operation of mounting the liquid elimination sheet 100 into the apparatus main body, which operation will be described in greater detail hereinafter, it is desirable that at least one of the cylindrical rods is rigidly secured to given positions and marks (not shown) are formed on the outside of the packing box 314 such that the positions of the rigidly secured rod are easily recognizable from outside.

The material of the first through third cylindrical rods 311, 312, 313 is not subject to any particular limitations and they may be made of vinyl chloride, although they are desirably made of paper from the viewpoint of low cost and lightweight. While the diameter of the first through third cylindrical rods 311, 312, 313 is not subject to any particular limitations, it is desirably between 30 mm and 50 mm because a curving or bending tendency can easily appear on the liquid elimination sheet 100 if the diameter is too small.

(Mounting of Liquid Elimination Sheet)

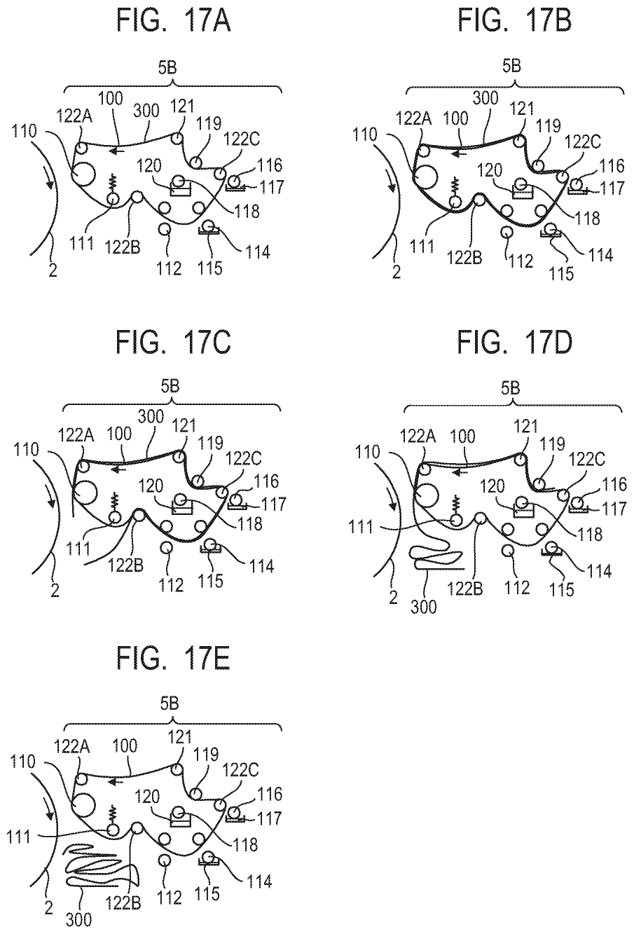

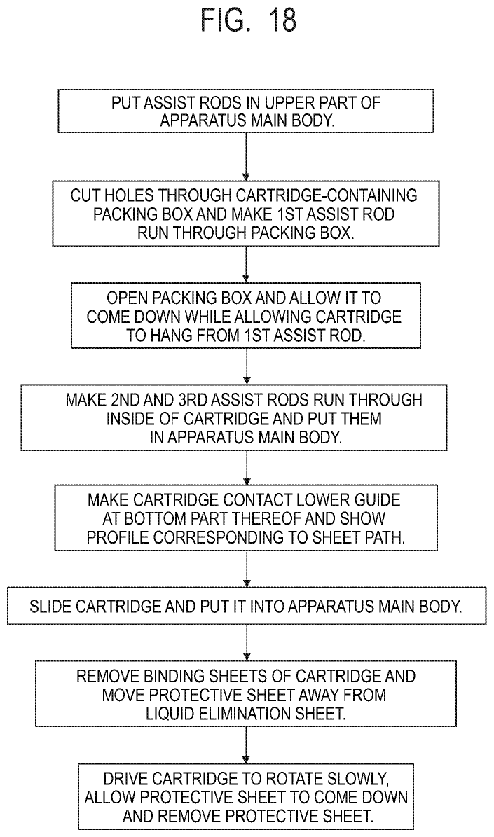

Now, the operation sequence of mounting the liquid elimination sheet 100 that is packed in a packing box 314 into the apparatus main body will be described below by referring to FIGS. 16A through 16H, 17A through 17E and 18. FIGS. 16A through 16H and 17A through 17E are schematic views of the absorption unit 5B taken out from the recording apparatus 1. FIGS. 16A through 16H and 17A through 17E shows the position of each of the modules of the absorption unit 5B and the final position (sheet path) of the liquid elimination sheet 100 in the absorption unit 5B is indicated by a two-dot chain line in FIGS. 16A through 16E.

In the absorption unit 5B shown in FIG. 16A, the first assist rod 401 is arranged as extension of the meandering correction roller 121 in a manner as shown in FIG. 16B. Then, the easy open parts 316 of the packing box 314 is opened and the first assist rod 401 is put into the first cylindrical rod 311 to hold the packing box 314 in suspension (see FIG. 16C). Then, as the packing box 314 is opened and moved down (taken away), the cartridge 310 hangs down from the assist rod 401 (see FIG. 16D). Thereafter, the second assist rod 402 and the third assist rod 403 are arranged as respective extensions of the suspension rollers 122A, 122C from the inside of the cartridge 310 (see FIG. 16E). At this stage of operation, an upper part of the cartridge 310 takes a shape that somewhat resembles the sheet path of the liquid elimination sheet 100 in the absorption unit 5B. Then, a lower guide 404 is arranged in a lower part of the absorption unit 5B. The lower guide 404 is a plate-shaped member having a cut part whose contour matches the sheet path of the liquid elimination sheet 100. The mounting jig for mounting the cartridge 310 that accompanies the apparatus main body may be used for the lower guide 404. When not in use, the lower guide 404 of this example is stored on the inner side of the front door of the apparatus main body so as to operate as part of a double door (not shown). A lower part of the cartridge 310 is put into the cut part of the lower guide 404 so as to follow the profile of the cut part (see FIG. 16F). At this stage of operation, the shape of the cartridge 310 is so controlled as to substantially match the sheet path of the liquid elimination sheet 100. Then, as shown in FIG. 16G, the cartridge 310 is pushed deep into the absorption unit 5B and the assist rods 401, 402, 403 and the lower guide 404 are moved away from the absorption unit 5B (see FIG. 16H).

Thereafter, the binding sheets 303 and protective sheet 300 are moved away from the cartridge 310 as shown in FIGS. 17A through 17E. Each of the binding sheets 303 is torn at the easy tear off part 306 (see FIG. 7) thereof and removed from the cartridge 310 that has been put into the inside of the apparatus main body (see FIG. 17A). From the viewpoint of facilitating the operation of removing the binding sheets 303, the cartridge 310 is preferably so packed that the easy tear off parts 306 are found at positions close to the front side of the absorption unit 5B and at the inner peripheral surface side of the cartridge 310 such that the binding sheets 301 can easily be torn by hand at the easy rear off parts 306. Then, the protective sheet 300 is grabbed with hand at the unfixed end parts (handle portions) thereof and pulled to separate the protective sheet 300 from the liquid elimination sheet 100 (see FIG. 17B). Then, the drive system of the absorption unit 5B is driven slowly to gradually move the protective sheet 300 away from the liquid elimination sheet 100 and allow the protective sheet 300 to automatically fall downward in the absorption unit 5B as shown in FIGS. 17C through 17E. The protective sheet 300 that has fallen down is then taken out and moved away from the apparatus main body to the outside. By following the above-described sequence of operation, the operator can mount the liquid elimination sheet 100 into the apparatus main body and place it in position without directly touching the liquid elimination sheet 100 and hence without bending and damaging the liquid elimination sheet 100. After mounting the liquid elimination sheet 100 in position, tension is applied to the liquid elimination sheet 100 by moving the related rollers shown in FIGS. 17A through 17E to their respective operating positions to make it ready for use.

In this example, a cartridge 310 is prepared in advance by attaching a protective sheet 300 and binding sheets 303 to a liquid elimination sheet 100 and amounted in the absorption unit 5B of the recording apparatus by following the above-described sequence of operation in order to prevent the liquid elimination sheet 100 from being bent and damaged. However, the present disclosure essentially consists in protecting a liquid elimination sheet 100 by means of a protective sheet 300 (by forming an endless belt laminate) and a cartridge 310 may not necessarily be prepared in advance.

### Example 2

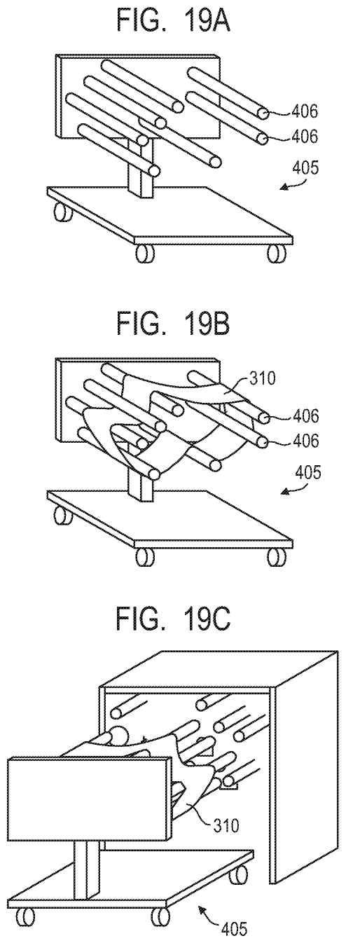

FIGS. 19A through 19C schematically illustrate Example 2 of this disclosure. In Example 1, assist rods 401, 402, 403 and a lower guide 404 are fitted to the apparatus main body in order to make the cartridge 310 show a profile that matches the profile of the sheet path when the cartridge 310 is put into the absorption unit 5B. On the other hand, a profiling unit (mounting jig) 405 as shown in FIG. 19A is employed in this example. The profiling unit 405 has a plurality of profiling rods (assist rods) 406. As shown in FIG. 19B, a cartridge 310 is fitted to the profiling unit 405 such that the profiling rods 406 are brought into the inside of the cartridge 310 at respective appropriate positions. With this arrangement, the liquid elimination sheet 100 is positionally so controlled as to show a profile that practically agrees with the profile of the sheet path. Then, as shown in FIG. 19C, the profiling unit 405 is placed at a position located vis-à-vis the absorption unit 5B and the cartridge 310 is driven to slide into the inside of the apparatus main body from that position and mounted into the apparatus main body. The profiling unit 405 is provided at the bottom part thereof with casters and hence can be moved around with ease.

As described above, employing the profiling unit 405 in this example facilitates the operation of mounting the liquid elimination sheet 100 protected by the protective sheet 300 into the apparatus main body from the cartridge 310 without any damage or bends.

### Example 3

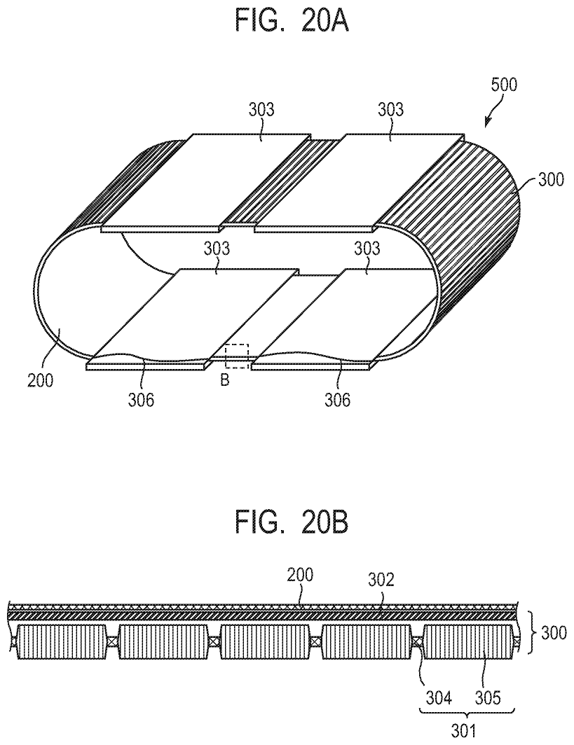

FIGS. 12, 20A and 20B schematically illustrate Example 3 of the present disclosure. In Example 3, a protective sheet 300 according to the present disclosure is applied to a belt-shaped transfer body of a transfer type recording apparatus.

FIG. 12 schematically illustrates a recording apparatus for which a protective sheet according to the present disclosure can be used. With this recording apparatus, an image is formed on a belt-shaped transfer body 200 by means of recording heads 30 and the moisture of the image is eliminated by means of a drying heater 150. The image from which moisture is removed is then transferred onto a recording sheet 151 that is conveyed to the belt-shaped transfer body 200 by a conveyance roller 152. After the image transfer, the belt-shaped transfer body 200 is cleaned by a cleaning roller 153 and the dust and the coloring materials that are left, if slightly, on the belt-shaped transfer body 200 are eliminated. The belt-shaped transfer body 200 is suspended by suspension rollers 155, 156 and tensile force is applied to it by a tension roller 154. The sheet path of the belt-shaped transfer body 200 is complicated like the sheet path of the liquid elimination sheet 100 of Example 1 and that of Example 2. Additionally, an image is directly formed on the belt-shaped transfer body 200 and hence, if the belt-shaped transfer body 200 is bent and/or damaged, defective images can be produced. In other words, the belt-shaped transfer body 200 requires very careful handling. FIGS. 20A and 20B schematically illustrate a protective sheet 300 for protecting the belt-shaped transfer body 200. In FIGS. 20A and 20B, the components similar to those of Example 1 are denoted by the same reference symbols and will not be described repeatedly. The protective sheet 300 comprises a cushion material 302 and a hard shell 301. The shell 301 shows a low bending stiffness in the circumferential direction and a high bending stiffness in the width direction of the belt-shaped transfer body 200. A cartridge is formed as the belt-shaped laminate of the belt-shaped transfer body 200, the cushion material 302 and the shell 301 are bound together and rigidly held to each other by means of binding sheets 303. Thus, a protective sheet 300 according to the present disclosure is also applicable to a recording apparatus comprising a belt-shaped transfer body 200 having a configuration as described above. This example can be modified such that a photosensitive belt is employed for the endless belt. Then, the photosensitive endless belt can be protected by means of a protective sheet in a manner as described above.

### Example 4

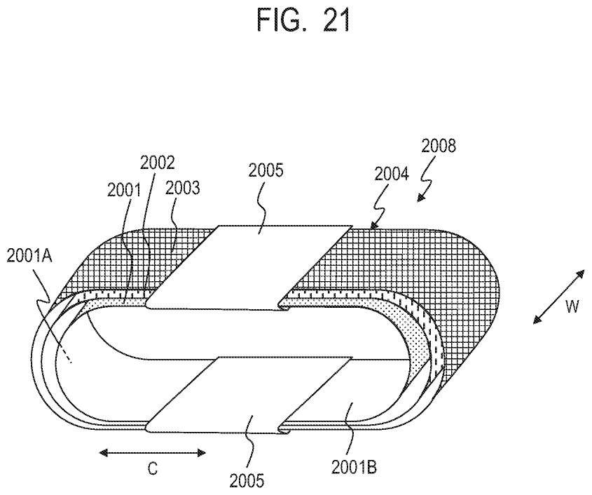

FIG. 21 is a schematic perspective view of a laminate 2004 of an endless belt 2001 and protective sheets 2002, 2003 according to Example 4 of the disclosure. In FIG. 21, the laminate 2004 is made to show a simple profile having curved portions at opposite ends of the laminate 2004 where its direction is changed by 180°. The laminate 2004 includes the above-described endless belt 2001 and first and second protective sheets 2002, 2003 that are wound around the endless belt 2001 along the surface to be protected 2001A of the endless belt 2001. The first protective sheet 2002 is arranged between the endless belt 2001 and the second protective sheet 2003. In other words, the endless belt 2001 is arranged at the innermost periphery of the laminate 2004, the first protective sheet 2002 is arranged outside the endless belt 2001, and the second protective sheet 2003 is arranged outside the first protective sheet 2002. No protective sheet is arranged on the rear surface 2001B of the endless belt 2001 and hence exposed to the outside. The first protective sheet 2002 is wound loosely to such an extent that it is allowed to be positionally deviated relative to the endless belt 2001 in the circumferential direction C. The second protective sheet 2003 is also wound loosely to such an extent that it is allowed to positionally deviated relative to the first protective sheet 2002 in the circumferential direction C. For the reason that will be described hereinafter, the second protective sheet 2003 is wound more loosely than the first protective sheet 2002. Differently stated, the value obtained by subtracting the circumferential length of the first protective sheet 2002 from the circumferential length of the second protective sheet 2003 is made greater than the value obtained by subtracting the circumferential length of the endless belt 2001 from the circumferential length of the first protective sheet 2002.

The first protective sheet 2002 is made of a soft material that does not damage the surface to be protected 2001A of the endless belt 2001. The degree of softness of the material can typically be defined by using a shore hardness value. The first protective sheet 2002 is made at least softer than the second protective sheet 2003. A sheet made of a soft material such as polyethylene or polyurethane is preferably employed for the first protective sheet 2002. Any of various foamed buffer materials in the form of foamed plastic sheet such as polyethylene foam sheet, polyurethane foam sheet or the like and having many bubble-containing surface protrusions can suitably be used for the first protective sheet 2002 because those materials are soft and additionally provide a high pressure dispersion effect.

The second protective sheet 2003 is made to show a high bending stiffness in the width direction W that is greater than the bending stiffness of the first protective sheet 2002 in the width direction W. Since the first protective sheet 2002 is made of a soft material, the resistance of the surface to be protected 2001A against contacts and rubbings is remarkably improved by the first protective sheet 2002 but it may sometimes be difficult for the first protective sheet 2002 to secure a satisfactory level of bending stiffness for the surface to be protected 2001A. For this reason, it may also sometimes be difficult for the first protective sheet 2002 alone to prevent the endless belt 2001 from being bent in the width direction W. In other words, if the endless belt 2001 is simply covered by the first protective sheet 2002, the endless belt 2001 can easily be bent even in a state where no tensile force is applied to it and it may sometimes be difficult to prevent the surface to be protected 2001A from being bent and damaged. Thus, in this example, the second protective sheet 2003 is laid on the outer surface of the first protective sheet 2002. Because of the high rigidity of the second protective sheet 2003, the second protective sheet 2003 operates as support for preventing the endless belt 2001 from being bent in the width direction W. Since the first protective sheet 2002 protects the surface to be protected 2001A of the endless belt 2001, the second protective sheet 2003 never directly contacts the surface to be protected 2001A of the endless belt 2001. Therefore, no problem arises when the second protective sheet 2003 is made of a hard material and hence it is easy to make the second protective sheet 2003 show a high bending stiffness. Meanwhile, the laminate 2004 may forcibly be curved in a complicated matter in the circumferential direction C when the laminate 2004 is mounted in the recording apparatus main body and when the laminate 2004 is packaged as will be described hereinafter. For this reason, the second protective sheet 2003 preferably shows a low rigidity in the circumferential direction C. The above-described requirements of the second protective sheet 2003 can be satisfied when a sheet having a bellows-like structure or a bamboo blind-like structure or a sheet formed by alternately arranging in the circumferential direction C parts showing a high bending stiffness and parts showing a low bending stiffness in the width direction W is adopted for the second protective sheet 2003. In more practical terms, a sheet that is referred to as lined cardboard and produced by way of a process of reducing the bending stiffness in a direction or a sheet referred to as rolled cardboard can preferably be used for the second protective sheet 2003. While the second protective sheet 2003 may be a single layer sheet and, if necessary, may alternatively be a multilayer sheet so long as it satisfies the requirement of showing a high bending stiffness in the width direction W and a low bending stiffness in the circumferential direction C as a whole.

Binding members 2005 are wound around the laminate 2004 of the endless belt 2001, the first protective sheet 2002 and the second protective sheet 2003 in the width direction W. In this specification, the laminate 2004 wound by the binding members 2005 is referred to as laminate assembly 8. The binding members 2005 align the endless belt 2001, the first protective sheet 2002 and the second protective sheet 2003 in the width direction W and limit their mutual positional deviations in the width direction W. Note, however, the binding members 2005 are preferably wound around the endless belt 2001, the first protective sheet 2002 and the second protective sheet 2003 to such an extent of tightness that they may not positionally deviate too much in the width direction W. Additionally, in view of the packing method that will be described hereinafter, it is not desirable that the binding members 2005 are wound around the endless belt 2001, the first protective sheet 2002 and the second protective sheet 2003 such that their movements are completely restricted in the circumferential direction C. In other words, the binding members 2005 are preferably wound around the endless belt 2001, the first protective sheet 2002 and the second protective sheet 2003 to such an extent that they are allowed to positionally deviate from each other in the circumferential direction C. For example, the binding members 2005 are wound around the endless belt 2001, the first protective sheet 2002 and the second protective sheet 2003 such that, when the inside cores 2006A, 2006B (which will be described in greater detail hereinafter) are moved into the inside of the laminate 2004 and the laminate 2004 is lifted by using the inside cores 2006A, 2006B, the second protective sheet 2003 is not remarkably moved away from the endless belt 2001 (does not remarkably hang down) at a lower part of the laminate 2004.

The material of the binding member 2005 is not subject to any particular limitations and they may be made of popularly available plastic film. When binding the laminate 2004 with the binding members 2005, the film sheets of the binding members 2005 are wound around the laminate 2004 in the width direction W and the opposite ends of each of the film sheets may be rigidly held to each other by means of an adhesive tape. The binding members 2005 may be strap-like ones but they are preferably filmy broad ones. The use of filmy broad binding members 2005 can avoid the endless belt 2001 from being concentratedly stressed at the connected edges thereof. A required number of binding members 2005 may appropriately be used. Two wide filmy members are arranged at respective positions that practically divide the circumference of the laminate 2004 into equal two parts in this example but three or more filmy narrow binding members 2005 may alternatively be used.

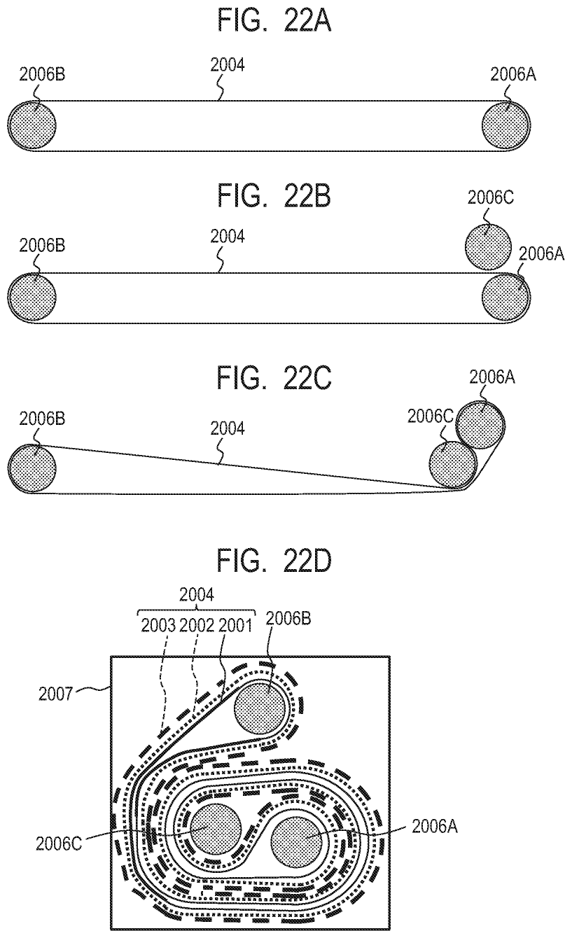

FIGS. 22A through 22D schematically illustrate the steps of the method of packing the laminate 2004 of this example. For the sake of convenience, the laminate 2004 is shown by a single line in FIGS. 22A through 22C. Firstly, as shown in FIG. 22A, the first inside core 2006A and the second inside core 2006B are moved into the inside of the endless belt 2001. The first inside core 2006A and the second inside core 2006B are cylindrical bodies that are to be so placed as to extend over the entire width of the laminate 2004 in the width direction W. Tensile force is applied to the laminate 2004 by the first and second inside cores 2006A, 2006B. The first inside core 2006A and the second inside core 2006B are arranged at respective positions that divide the circumference of the inner peripheral part of the laminate 2004 into two equal halves. Since the first inside core 2006A and the second inside core 2006B are brought into contact with the rear surface 2001B of the endless belt 2001, the surface to be protected 2001A of the endless belt 2001 is not adversely affected by them. Then, as shown in FIG. 22B, an outside core 2006C is arranged on the outer peripheral surface of the laminate 2004. More specifically, the outside core 2006C is arranged at a position located vis-à-vis the first inside core 2006A with the laminate 2004 interposed between them. The outside core 2006C is also a cylindrical body that extends over the entire width of the laminate 2004 in the width direction W and has a shape and dimensions same as those of the first and second inside cores 2006A, 2006B. Subsequently, as shown in FIG. 22C, the laminate 2004 is wound around the first inside core 2006A and the outside core 2006C, while the outside core 2006C is constantly being pressed against the first inside core 200A. The outside core 2006C faces the outer peripheral surface of the laminate 2004 but, since the first protective sheet 2002 and the second protective sheet 2003 are interposed between the endless belt 2001 and the outside core 2006C, the surface to be protected 2001A of the endless belt 2001 is kept protected. In the step shown in FIG. 22C, positional deviations (relative displacements) arise among the endless belt 2001, the first protective sheet 2002 and the second protective sheet 2003 in the circumferential direction C due to their thicknesses. Since the first protective sheet 2002 is soft and elastic, the positional deviation between the endless belt 2001 and the first protective sheet 2002 is absorbed by deformation of the first protective sheet 2002. To the contrary, the second protective sheet 2003 is made to have a thickness greater than both the thickness of the endless belt 2001 and that of the first protective sheet 2002 in order to secure a required degree of bending stiffness for the second protective sheet 2003 and hence less liable to be deformed because of its high rigidity. In view of this fact, the positional deviation between the endless belt 2001 and the second protective sheet 2003 needs to be absorbed by making in advance the circumferential of the second protective sheet 2003 greater than that of the endless belt 2001 to a certain extent. As described above, in this example, when the second protective sheet 2003 is wound around the outer surface of the first protective sheet 2002, the second protective sheet 2003 is brought into contact with the first protective sheet 2002 not tightly but with a certain degree of looseness. Ultimately, the laminate 2004 is rolled in a manner as shown in FIG. 22D and contained in a packing box 2007 in the rolled state.

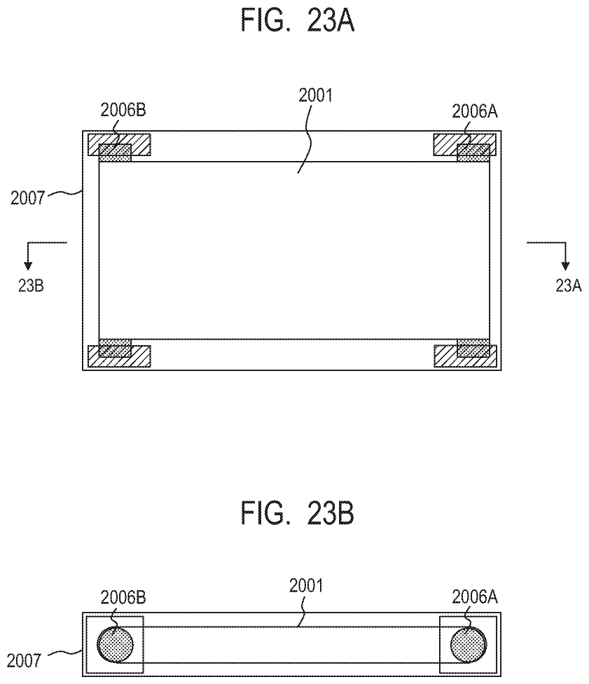

FIGS. 23A and 23B schematically illustrate how a known endless belt 2001 is packed in a conventional packing box. FIG. 23A is a schematic plan view of the packing box 107 in which an endless belt 2001 is contained and FIG. 23B is a schematic cross-sectional view taken along line 23B-23B in FIG. 23A. The endless belt 2001 is contained in the packing box 107 in a state where tensile force is applied to the endless belt 2001 by a pair of inside cores 2006A, 2006B (in the state shown in FIG. 22A). The distance between the two cores 2006A, 2006B is about a half of the circumference of the endless belt 2001. Since the endless belt 2001 is held in contact only with the cores 2006A, 2006B and tensile force is applied to it, rubbings and bents can hardly take place to the endless belt 2001. Therefore, the packing method illustrated in FIGS. 23A and 23B is a preferable one from the viewpoint of protecting the endless belt 2001. However, this packing method hardly allows dimensional reductions of the packing box 107. For example, if the endless belt 2001 is a liquid elimination belt 101 of a commercial high speed printer, the packing box can show a width of 80 cm and a length of 3 m because the ink absorbed from the printed images needs to be recovered at a separate position and the endless belt 2006 is required to adapt itself to large format printing. If such is the instance, the front and rear surfaces of the packing box 107 may be about 1-m wide and about 1.5-m long. The above description will also apply to the intermediate transfer body belt 201. On the other hand, in this example, the width W of the endless belt 2001 (the packing box 2007) is substantially the same as the one shown in FIGS. 23A and 23B but the dimensions of the front and rear surfaces of the packing box 2007 are about 25×90 cm, which are above ⅙ of those of the packing box shown in FIGS. 23A and 23B. This fact provides great advantages in terms of the manufacturing cost of the packing box 2007, the transportation cost of the packing box 2007 and the space required for storing the packing box 2007.

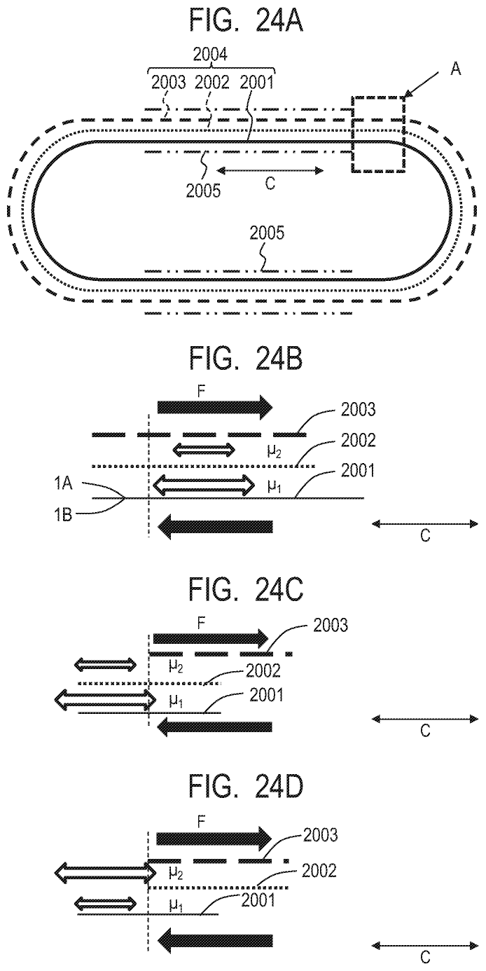

FIG. 24A is a schematic lateral view of laminate 2004 and FIG. 24B is an enlarged schematic view of part A shown in FIG. 24A. While the laminate 2004 is wound into a roll, in other words while the laminate 2004 is turned from the state shown in FIG. 22A into the state shown in FIG. 22D, the endless belt 2001, the first protective sheet 2002 and the second protective sheet 2003 are positionally shifted relative to each other in the circumferential direction C. At this time, shearing force F arises between the endless belt 2001 and the second protective sheet 2003. FIG. 24B schematically shows the shearing force F between the endless belt 2001 and the second protective sheet 2003. Such shearing force F also arises when the roll of the laminate 2004 is unwound, in other word, when the laminate 2004 is turned from the state shown in FIG. 22D into the state shown in FIG. 22A. Then, therefore, the endless belt 2001 and the first protective sheet 2002 can contact and rub each other during the execution of the above-described steps.

In this example, since the first protective sheet 2002 is made of a soft and easily deformable material, the first protective sheet 2002 can easily follow any deformation of the endless belt 2001. On the other hand, since the second protective sheet 2003 is highly rigid and less liable to be deformed, the second protective sheet 2003 can poorly follow any deformation of the first protective sheet 2002. In more generally understandable terms, the coefficient of friction μ1 between the surface to be protected 2001A and the corresponding surface of the first protective sheet 2002 is made greater than the coefficient of friction μ2 between the other surface of the first protective sheet 2002 and the corresponding surface of the second protective sheet 2003. As for coefficients of friction, both the coefficient of static friction and the coefficient of dynamic friction are preferably taken into consideration. In other words, the coefficient of static friction and the coefficient of dynamic friction between the surface to be protected 2001A and the corresponding surface of the first protective sheet 2002 are preferably respectively made greater than the coefficient of static friction and the coefficient of dynamic friction between the other surface of the first protective sheet 2002 and the corresponding surface of the second protective sheet 2003. When the coefficient of static friction shows a large value, the positional deviation hardly occurs, while when the coefficient of dynamic friction shows a large value, the extent of positional deviation is minimized even if a positional deviation takes place. Since μ1>μ2, the positional deviation in the circumferential direction C between the surface to be protected 2001A and the second protective sheet 2003 attributable to shearing force F mainly appears between the first protective sheet 2002 and the second protective sheet 2003 as shown in FIG. 24C. Differently stated, the positional deviation in the circumferential direction C between the surface to be protected 2001A and the second protective sheet 2003 that is attributable to shearing force F is absorbed or alleviated by the positional deviation in the circumferential direction C between the first protective sheet 2002 and the second protective sheet 2003. No positional deviation takes place between the endless belt 2001 and the first protective sheet 2002 or, if a positional deviation takes place between the endless belt 2001 and the first protective sheet 2002, it takes place only slightly and hence the influence, if any, of rubbing or the like by the first protective sheet 2002 on the surface to be protected 2001A of the endless belt 2001 is minimized. If, on the other hand, μ1<μ2, the positional deviation in the circumferential direction C mainly takes place between the endless belt 2001 and the first protective sheet 2002 and the surface to be protected 2001A of the endless belt 2001 is apt to be rubbed. Since the first protective sheet 2002 is made of a soft material, the influence of rubbing to the surface to be protected 2001A of the endless belt 2001 is small but such rubbing can eventually damage the surface to be protected 2001A of the endless belt 2001.

Possible causes that give rise to shearing force F include vibrations during transportation. Since the binding effect of the binding members 2005 is not particularly remarkable, slight positional deviations take place between the endless belt 2001 and the second protective sheet 2003 when they are packed in a packing box and exposed to vibrations. However, positional deviations caused by such vibrations in the packing box mainly take place between the first protective sheet 2002 and the second protective sheet 2003 and hence the surface to be protected 2001A of the endless belt 2001 will be less affected by such vibrations.

When the endless belt 2001 that is packed in a manner as illustrated in FIGS. 23A and 23B is taken out and mounted into the printer main body, the tensile force that has been applied to the endless belt 2001 will be lost after it is taken out from the packing box 107 and hence the endless belt 2001 will easily be bent in the width direction W. In addition, the endless belt 2001 needs to be wound around rollers that are arranged in a complicated manner as shown in FIG. 1. Furthermore, the endless belt 2001 needs to be brought onto cantilever-like rollers from the free ends thereof in the axial direction of the rollers. Thus, it is very difficult to properly mount the endless belt 2001, which can easily be bent and whose surface can easily be damaged by rubbing, into the printer main body without damaging the surface to be protected 2001A because the surface to be protected 2001A is neither protected at all nor provided with an anti-bending support.

On the other hand, in this example, the endless belt 2001 is mounted into the printer main body in a manner as described below. First, the laminate 2004 is moved to slide along rollers in the axial direction of the rollers until it becomes hung by the rollers. Since the laminate is bound by the binding members 2005, the endless belt 2001, the first protective sheet 2002 and the second protective sheet 2003 are not positionally deviated from each other to a large extent. In other words, the risk that the surface to be protected 2001A of the endless belt 2001 becomes exposed and damaged and the risk that the surface to be protected 2001A is touched, rubbed and damaged by the first protective sheet 2002 are minimized. Additionally, while the endless belt 2001 is free from any tensile force in this state, the second protective sheet 2003 takes the role of a support and hence the risk that the endless belt is bent is also minimized. Then, each of the binding members 2005 is cut at the font side thereof and taken out from the laminate 2004. Additionally, each of the first protective sheet 2002 and the second protective sheet 2003 is cut at an arbitrarily selected position as viewed in the circumferential direction C and, while the endless belt 2001 is forced to rotate at low speed, the first protective sheet 2002 and the second protective sheet 2003 are gradually separated from the endless belt 2001. Then, as a result, the first protective sheet 2002 and the second protective sheet 2003 can be taken out from the endless belt without applying a heavy load to the surface to be protected 2001A of the endless belt 2001.

### Specific Example

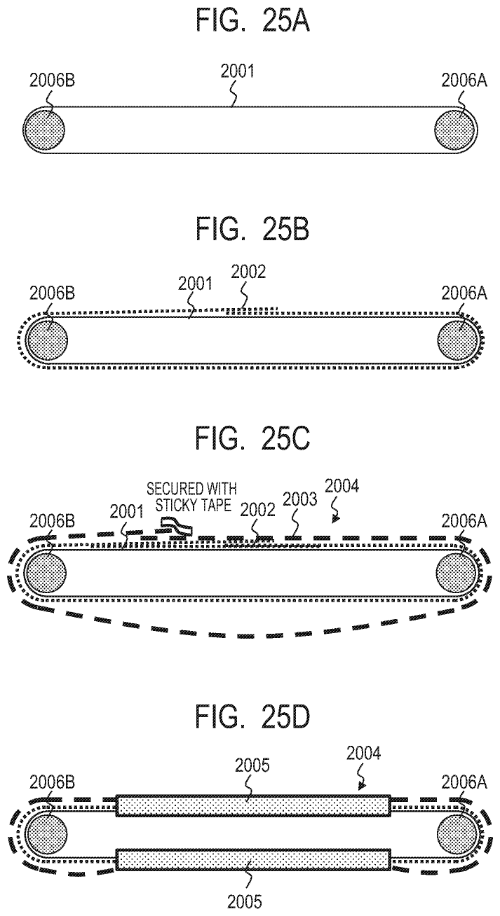

As a specific example of endless belt 2001, a liquid elimination belt 101 to be used for an inkjet printer was prepared. The belt was 80-cm wide and 2.8-m long. The surface to be protected 2001A of the liquid elimination belt 101 was produced by a porous layer made of polytetrafluoroethylene (PTFE) and having a pore size of 10 μm and the rear surface 2001B of the liquid elimination belt 101 was produced by an unwoven sheet of polyphenylsulfide (PPS) fibers. As shown in FIG. 25A, two plastic-made cores 2006A, 2006B were moved into the inside of the liquid elimination belt 101 and put on a dedicated stand. Then, tensile force was applied to the liquid elimination belt 101 by the cores 2006A, 2006B. Thereafter, a polyethylene (PE) foam sheet that was about 1-mm thick, 81-cm wide and 3-m long, was prepared as the first protective sheet 2002 and wound around the outer peripheral surface of the endless belt 2001 as shown in FIG. 25B. Subsequently, a polypropylene (PP)-made lined plastic cardboard that was 3-mm thick, 22-cm wide and 3-m long was wound around the outer peripheral surface of the first protective sheet 2002 as the second protective sheet 2003 and its opposite ends were secured to each other by means of a sticky tape as shown in FIG. 25C to form a laminate 2004. At this time, in view of the packing operation that came later, the opposite ends of the second protective sheet 2003 were secured to each other such that the second protective sheet 2003 was wound around the liquid elimination belt 101 and the first protective sheet 2001 not tightly but with a certain degree of slackness. Table 1 shows the coefficients of friction between the liquid elimination belt 101 and the first protective sheet 2002 and also the coefficients of friction between the first protective sheet 2002 and the second protective sheet 2003. It was confirmed that μ1 and μ2 showed a relationship of μ1>μ2.

TABLE 1

| | Coefficient | Coefficient |
|---|---|---|
| | of static | of dynamic |
| | friction | friction |
| Liquid elimination belt (surface to be | 2.3 | 1 |
| protected) - first protective sheet (PE | | |
| foam sheet) | | |
| First protective sheet (PE foam sheet) - | 0.8 | 0.5 |
| second protective sheet (PP-made lined | | |
| plastic cardboard | | |

Then, as binding members 2005, a pair of polyethylene (PE) films, each of which was 50-μm thick and 95-cm wide, were wound around the laminate 2004 of the liquid elimination belt 101, the first protective sheet 2002 and the second protective sheet 2003 as shown in FIG. 25D. The opposite ends of each of the binding members 2005 were secured to each other by means of a sticky tape at a position close to one of the opposite ends of the corresponding linear part of the laminate 2004 such that the binding members 2005 could easily be separated from the laminate at a later stage. The binding members 2005 were wound around the belt-shaped laminate 2004 at respective positions as shown in FIG. 25D. Then, the tensile force being applied to the liquid elimination belt 101 was reduced and another plastic-made core 2006C was brought in and the laminate 2004 was wound around the cores 2006C, 2006B to produce a roll as shown in FIG. 22D. Thereafter, the laminate 2004 was put into a cardboard-made packing box 2007 and packed as shown in FIG. 22D. Then, the package was subjected to a vibration test on an assumption that it was part of a logistics test. Subsequently, the package was unpacked and the sequence of operation shown in FIGS. 22A through 22D was reversely followed to remove the binding members 2005, the second protective sheet 2003 and the first protective sheet 2002 and observe the surface to be protected 2001A of the liquid elimination belt 101. Any damage was not particularly observed on the surface to be protected 2001A produced by a PTFE porous layer.

Then, the liquid elimination belt 101 that was unpacked from the package was mounted into a roller system having a configuration as shown in FIG. 4A. The tensile force applying roller 23 was moved to its retreat position to put the liquid elimination belt 101 into a state of being substantially free from large tensile force and the laminate 2004 whose components were put together by the binding members 2005 was made to show a profile similar to that of the roller system and put around the rollers from the side of one of the rollers. After placing the laminate in position, the front side end-holding tapes of the binding members 2005 were removed to release the opposite ends of the binding members. Each of the binding members 2005 could be removed to the front side by pulling one of the opposite ends of the binding member 2005. Subsequently, the tape holding the opposite ends of the second protective sheet 2003 was peeled off to release the opposite ends of the second protective sheet 2003 and the roller system was driven to slowly rotate from one of the opposite ends of the roller system. One of the opposite ends of the second protective sheet 2003 and the corresponding one of the opposite ends of the first protective sheet 2002 were pulled in synchronism with the rotation of the roller system. Thus, the first and second protective sheets 2002, 2003 could be separated from the liquid elimination belt 101, which was kept mounted on the roller system. Thus, the liquid elimination belt 101 could be mounted on the roller system in the above-described manner without bending or damaging the surface to be protected 2001A of the liquid elimination belt 101.

### Comparative Example

A liquid elimination belt 101 similar to that of Specific Example was used and the operation steps of Specific Example were also followed down to the step shown in FIG. 25A in Comparative Example. Then, the PE foam sheet and the PP-made lined plastic cardboard same as those of Specific Example were bonded to each other by means of a double-sided tape. The PE foam sheet and the PP-made lined plastic cardboard that were bonded to each other were wound around the outer peripheral surface of the liquid elimination belt 101 with the PE foam sheet directly held in contact with the liquid elimination belt 101. The front ends of the PE foam sheet were secured to each other by means of an adhesive tape and those of the PP-made lined plastic cardboard were also secured to each other in a similar way to produce a laminate 2004. Since the coefficients of friction between the PE foam sheet and the PP-made lined plastic cardboard were very large, a relationship of μ1<μ2 was observed. The laminate 2004 was wound by a pair of binding members 2005 that were made of PE film and packed as in the instance of the laminate 2004 of Specific Example. Like the package of Specific Example, the package of Comparative Example was also subjected to a vibration test and the package was unpacked to observe the surface to be protected 2001A of the liquid elimination belt 101 as in Specific Example. The luster of the surface to be protected 2001A of the liquid elimination belt 101 was found to be uneven. In other words, areas where the surface was apparently rubbed and areas where the surface conditions were practically left unchanged were observed. The areas where the surface was apparently rubbed were observed through a microscope to find that the PTFE porous layer had been damaged. Since the above-identified relationship was observed for the coefficients of friction in Comparative Example, it may be safe to assume that the positional deviations that took place between the endless belt 2001 and the second protective sheet 2003 were actually found mostly between the endless belt 2001 and the first protective sheet 2002 and hence the endless belt 2001 was rubbed to give rise to the above-described damages on the surface to be protected 2001A.

As described in detail above, a protective sheet according to the present disclosure can be applied to a liquid elimination sheet 100 that is to be brought into contact with a transfer body 2, to a belt-shaped transfer body 200 that operates as transfer body by itself, to a photosensitive belt or any of many other endless belt sheets that are to be mounted so as to move along a complicated path (sheet path). In any instance of application, a protective sheet according to the present disclosure can minimize bents and damages that can take place during the operation of mounting the endless belt sheet.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-148533, filed Aug. 7, 2018, and Japanese Patent Application No. 2018-148532, filed Aug. 7, 2018, all of which are hereby incorporated by reference herein in their entirety.

What is claimed is:

1. A protective sheet for covering a surface of an endless belt sheet to protect the surface, a bending stiffness of the protective sheet being lower in a circumferential direction of the endless belt sheet than in a width direction orthogonal relative to the circumferential direction.

2. The protective sheet according to claim 1, comprising high rigidity parts and low rigidity parts showing a bending stiffness lower than the high rigidity parts in the circumferential direction of the endless belt sheet, the high rigidity parts and the low rigidity parts being alternately arranged along the circumferential direction.

3. The protective sheet according to claim 2, wherein
thicknesses of the low rigidity parts are smaller than thicknesses of the high rigidity parts.

4. The protective sheet according to claim 3, wherein
the low rigidity parts are located between opposite surfaces of the high rigidity parts as viewed in a thickness direction.

5. The protective sheet according to claim 3, wherein
the high rigidity parts and the low rigidity parts are made of the same resin material and the high rigidity parts have cavities in the inside, whereas the low rigidity parts show a thickness smaller than that of the high rigidity part as cavities in the inside thereof are crushed and deformed.

6. The protective sheet according to claim 2, wherein
the low rigidity parts are made of a material having a flexibility higher than a flexibility of a material of the high rigidity parts.

7. The protective sheet according to claim 2, wherein the protective sheet has a multilayer structure including
a contacting side layer to be brought into contact with the surface of the endless belt sheet and
a noncontacting side layer laid on a surface of the contacting side layer opposite to a surface to be brought into contact with the surface to be protected and the noncontacting side layer is a layer where the high rigidity parts and the low rigidity parts are alternately arranged in the circumferential direction.

8. The protective sheet according to claim 7, wherein
the noncontacting side layer has a stiffness higher than a stiffness of the contacting side layer.

9. The protective sheet according to claim 1, wherein the protective sheet has an unfixed end part for operating as a handle portion to be pulled out to separate the protective sheet from the surface of the endless belt sheet.

10. An endless belt laminate comprising an endless belt sheet and a protective sheet covering a surface of the endless belt sheet to protect the surface, a bending stiffness of the protective sheet being lower in a circumferential direction of the endless belt sheet than in a width direction orthogonal relative to the circumferential direction.

11. The endless belt laminate according to claim 10, wherein
the endless belt sheet is configured to fit to a body of a recording apparatus and brought into contact with a transfer body carrying an image formed thereon of the recording apparatus to absorb at least part of a liquid component contained in the image.

12. The endless belt laminate according to claim 10, wherein
the endless belt sheet operates as a belt-shaped transfer body to be fitted to a body of a recording apparatus and carry an image formed thereon.

13. An endless belt assembly comprising an endless belt laminate and a binding member rigidly securing the endless belt laminate, the endless belt laminate comprising an endless belt sheet and a protective sheet covering a surface of the endless belt sheet to protect the surface, a bending stiffness of the protective sheet being lower in a circumferential direction of the endless belt sheet than in a width direction orthogonal relative to the circumferential direction.

14. The endless belt assembly according to claim 13, wherein
the binding member has an easy tear off part to be torn off to allow the binding member to be removed from the endless belt laminate with ease and the easy tear off part is arranged so as to be located on an inner peripheral surface side of the endless belt laminate.

15. The endless belt assembly according to claim 13, further comprising
a pair of first shafts arranged at positions dividing a circumference of an inner peripheral surface of the endless belt laminate into two halves, and
a second shaft arranged so as to be held in contact with an outer peripheral surface of the endless belt laminate,
wherein one of the first shafts and the second shaft are placed side by side with a part of the endless belt laminate interposed between them, the endless belt laminate being wound around the two shafts placed side by side for several times, and
wherein the other first shaft being placed at a position located side by side with either the former first shaft or the second shaft, with the endless belt laminate wound around for several times interposed between them.

16. A package comprising an endless belt assembly according to claim 15 and a packing box containing the assembly, the packing box being provided with a notch to be engaged with a part of at least one of the shafts or being provided with a marking indicating a position of at least one of the shafts.

17. A mounting jig for mounting the endless belt sheet taken out from an endless belt assembly according to claim 13 into a body of a recording apparatus, the mounting jig comprising a plurality of profile rods to be put inside of an inner periphery of the endless belt laminate, the profile rods defining a profile of the endless belt sheet.
